(19) United States
(12) Patent Application Publication
(10) Pub. No.: US 2025/0129256 A1
(43) Pub. Date: Apr. 24, 2025

(54) POLYMERIC PARTICULATE MATERIAL

(71) Applicant: THE UNIVERSITY OF NOTTINGHAM, Nottingham, Nottinghamshire (GB)

(72) Inventors: Eduards KRUMINS, Nottingham, Nottinghamshire (GB); Samuel IRVING, Nottingham, Nottinghamshire (GB); Steven HOWDLE, Nottingham, Nottinghamshire (GB); Ruth GOODRIDGE, Nottingham, Nottinghamshire (GB); Christopher John TUCK, Nottingham, Nottinghamshire (GB)

(21) Appl. No.: 18/687,894

(22) PCT Filed: Aug. 31, 2022
(86) PCT No.: PCT/GB2022/052226

§ 371 Date: Feb. 29, 2024

(30) Foreign Application Priority Data
Aug. 31, 2021 (GB) 2112373.2

(51) Int. Cl. C09D 7/65; B29C 64/153; B29K 33/00; B29K 77/00; B29K 105/00; B33Y 10/00; B33Y 70/10; C09D 5/14; C09D 7/41; C09D 177/04

(52) U.S. Cl. CPC C09D 7/65; B29C 64/153; B33Y 10/00; B33Y 70/10; C09D 5/14; C09D 7/41; C09D 177/04; B29K 2033/12; B29K 2077/00; B29K 2105/0011; B29K 2105/0032; B29K 2995/0077

(57) ABSTRACT

The invention provides particulate material suitable for use in manufacturing a three-dimensional object, the material comprising a plurality of particles. Each particle has a thermoplastic polymeric core; and a polymeric shell that coats the polymeric core. The polymeric core makes up 75 wt % or more of each particle. The polymeric shell is formed from a co-polymer of a major monomer and a minor monomer, wherein the major monomer comprises a polymerisable group, and the minor monomer comprises (i) a polymerisable group; and (ii) a functional component, and wherein the co-polymer is formed by reaction of the polymerisable group on the major monomer with the polymerisable group on the minor monomer.

The present invention relates to polymeric particulate materials that can be used in manufacturing 3D objects, and especially in 3D printing, such as powder bed fusion 3D printing technique, e.g. Selective Laser Sintering (SLS) or Multi Jet Fusion (MJF). The invention also relates to methods of making said material, and methods of manufacturing a 3D object using said material.

### BACKGROUND TO THE INVENTION

Additive manufacturing (AM), also known as 3D printing (3DP), has become popular as a route to manufacturing polymeric products. 3DP techniques include, but are not limited to, selective laser sintering (SLS), powder/binder jetting techniques such as multi jet fusion (MJF), extrusion-based techniques such as paste extrusion, fused deposition modelling, inkjet-based 3D printing (IJ3DP), stereolithographic techniques, and electrophotographic techniques.

Powder bed fusion techniques such as selective laser sintering have been used to produce parts for a variety of industries, such as the automotive, aerospace, and biomedical sectors. These products range from gearboxes for race cars to turbine blades to prosthesis and implants.

SLS affords the user many advantages, such as the ability to: prototype and print rapidly, build complex architectures without needing support structures, and reuse un-sintered powder in future builds.

However, there remain limitations in relation to the materials that can be used in such techniques. There can be a desire to impart desired end characteristics into the printed product, such as colour, strength, water-repellency, anti-microbial properties, fire-retardancy, or conductivity.

The issue of imparting colour to polymeric material has, in particular, been considered. Polyamide (nylon) material, e.g. PA12, is widely used in 3D printing techniques such as SLS and this provides a white or grey end product. It is clearly desirable to be able to provide coloured end products.

CN110591124 describes the formation of a polyamide colour master batch. This provides a physical mix of the polyamide and the coloured paste, where the dispersion is improved by using supercritical carbon dioxide.

CN107746466 also provides a method of preparing a plastic colour master batch which uses supercritical state material to physically disperse inorganic pigment into a carrier resin such as a porous polypropylene resin, a porous polyamide resin, or a porous polystyrene resin.

GB1392261 describes fixing pigments or dyestuffs onto polyamide or polyester granules by plasticising the surface of the granules and allowing the pigments or dyestuffs to adhere to the surface.

U.S. Pat. No. 6,156,821 describes heating polymer particles so as to create a molten layer on their surface. Additive particles, such as pigments, are then forced into the molten or softened layer on the surface of the polymer particles to form a physical attachment.

FR2245701 describes mixing a synthetic polyamide with a dye that is soluble in the polyamide, in the presence of a polar organic solvent that dissolves the dye but not the polyamide, until the dye has diffused into the polyamide, and then removing the solvent.

“Experimental investigation of ink on powder used for selective laser sintering”, Ling Wai Ming et al, Journal of Materials Processing Technology, 174, 2006, 91-101, describes a modified SLS system in which ink is sprayed on to the powder before sintering.

“White and Brightly Colored 3D Printing Based on Resonant Photothermal Sensitizers”, Alexander W Powell et al, Nano Lett. 2018, 18, 11, 6660-6664, describes a system in which gold nano rod photosensitizers are mixed with PA12 polymer in powder form to form a composite powder that is a physical mixture of the components. 3D printing was carried out using the composite powder.

WO2018/189190 uses optically resonant particles dispersed within a powder material to be sintered, to enhance the sintering of the powder material, e.g. during 3D printing.

WO2019/134902 uses a reversible chromic material, such as a photochromic material, dispersed within a powder material to be sintered. This can be used to 3D print an object, such as a sensing device.

EP3572217 forms an electrically conductive inorganic component in situ, on a polymer bed in the form of powder or granules, before then sintering the polymer bed.

Therefore, the above solutions have focussed on physical mixing of coloured material with polymeric material.

Currently, in practice, the common approach when coloured parts are required is that they are coloured in a post processing operation with standard dyeing or spray-painting methods. This has issues in performance, however, because it can be difficult to achieve penetration of the dye throughout the product. This means that it is coloured on its exterior surface only, and after wear the part might lose its colour. Further, it requires an additional processing step, which is undesirable because it adds to cost, time, and complexity. Such post part production coating processes can also influence the dimensions of the 3D printed object, which is undesirable because it negates the benefit of 3D printing in terms of its accuracy and bespoke nature.

A further issue associated with 3D products can be the growth of microbes on the surface. In particular, biofilms are associations of microorganisms that develop on a surface and these represent a severe problem because they provide a microenvironment which contains excreted enzymes and other factors, allowing bacteria to evade host immune responses, including antibodies and cellular immune responses. Further, biofilms can be extremely resistant to removal and disinfection and can act to exclude antibiotics.

Therefore, it would be advantageous to be able to 3D print a product having a surface with intrinsic resistance against microbial attachment and/or biofilm formation.

Overall, there remains a need to be able to impart desired end characteristics into 3D printed products.

### SUMMARY OF THE INVENTION

The present inventors recognised that there was a need for a new route to imparting desired end characteristics (such as colour, strength, water-repellency, anti-microbial properties, fire-retardancy, or conductivity) into a 3D printed object, that would provide a cost-effective and straightforward manufacturing process, with improved flexibility regarding the achievable end characteristics.

For example, it was recognised that the widespread commercial use of 3D printing techniques such as SLS has been hindered by the inability to easily manufacture 3D objects in a range of different colours in a cost-effective manner.

In addition, the commercial marketplace needs to have the ability to provide other desired characteristics for end products, in addition to or instead of colour. These properties include but are not limited to: strength, anti-microbial properties, fire-retardancy, water-repellency (hydrophobicity), and conductivity.

In a first aspect, there is provided particulate material suitable for use in the manufacture of a three-dimensional object, the material comprising a plurality of particles each of which has:
a thermoplastic polymeric core; and
a polymeric shell that coats the polymeric core;
   wherein the polymeric core makes up 75 wt % or more of each particle,
   wherein the polymeric shell is formed from a co-polymer of a major monomer and a minor monomer,
   wherein the major monomer comprises a polymerisable group,
   wherein the minor monomer comprises (i) a polymerisable group; and (ii) a functional component,
   and wherein the co-polymer is formed by reaction of the polymerisable group on the major monomer with the polymerisable group on the minor monomer.

This material can be used in printing, specifically 3D printing, to form a three-dimensional object. This material may, in particular, be suitable for use in a powder bed fusion 3D printing technique, such as Selective Laser Sintering (SLS) or Multi Jet Fusion (MJF). It may also be suitable for use in other powder-based 3D printing processes that rely on thermal processing, such as electrophotography-based additive manufacturing. The material of the present invention may be used in a selective deposition-based additive manufacturing process using an electrostatographic engine, e.g. of the type developed by Evolve Additive Solutions Inc. and described in their patent applications, e.g. Core-shell polymer particles are of course known in the art. However, in the present invention there is added functionality beyond that found in a standard polymer shell in a core-shell particle. The polymer shell is a co-polymer that includes a repeating unit having an available functional component. This functionalised repeating unit derives from the minor monomer.

This additional available functional component is not involved in the co-polymerisation of the minor monomer with the major monomer.

The functional component is, in general, a functional moiety. This functional moiety is present in the copolymer. It is found as a repeating unit in the copolymer. It is part of the minor monomer that reacts during polymerisation to form the copolymer, but it is not itself part of the polymerization reaction. The functional component does not react during the polymerization reaction that forms the shell. The functional component could be a functional molecule and/or could be a reactive double bond.

The minor monomer can be considered as the active monomer. It provides the desired functionality. It comprises both (i) a polymerisable group; and (ii) a functional component. Thus, there are at least two different moieties within the minor monomer (active monomer)—there must be at least one moiety that is polymerisable (e.g. acrylate, methacrylate, acrylamide, methacrylamide) and in addition there must be at least one moiety that imparts functionality, such as colour, conductivity, water-resistance, anti-microbial properties, or flame retardancy. It may impart strength or other mechanical properties. It may impart the ability to crosslink, which in turn can lead to three-dimensional printed objects having improved mechanical properties such as strength.

The polymeric shell that coats the polymeric core includes the minor monomer, which provides functionality due to its functional component. The functional component remains available in the polymeric shell that is formed from the co-polymer of the major monomer and the minor monomer, because it is the polymerisable group (i) of the minor monomer that reacts with the major monomer to form the co-polymer. Thus, each polymeric particle that is 3D printed is provided with this functionality. This is beneficial in terms of ensuring that the functional effect is consistently provided throughout the 3D printed product.

The major monomer and the minor monomer are different. The polymeric shell is formed from a co-polymer formed from the polymerisation reaction of the major monomer and the minor monomer, providing a co-polymer where there are repeating units based on the major monomer and repeating units based on the minor monomer, whereby the repeating units based on the minor monomer include a functional component.

The major monomer suitably comprises a polymerisable group selected from: acrylate, methacrylate, acrylamide, methacrylamide, epoxy, isocyanate (—NCO), and vinyl (e.g. styrene (vinylbenzene) or divinyl benzene). Lactams (e.g. caprolactam), lactides, and carbonates can also be mentioned. However, these are non-limiting examples, and the skilled person will be aware of other polymerisable groups.

The minor monomer suitably comprises a polymerisable group selected from: acrylate, methacrylate, acrylamide, methacrylamide, epoxy, isocyanate (—NCO), and vinyl (e.g. styrene (vinylbenzene) or divinyl benzene). Lactams (e.g. caprolactam), lactides, and carbonates can also be mentioned. However, these are non-limiting examples, and the skilled person will be aware of other polymerisable groups.

In one embodiment, the polymeric shell is attached to the polymeric core via covalent attachment, or via physisorption, or via interpenetration.

The functional component may have one or more of the following properties: colour (dye), anti-static, hydrogen bonding, electro-dispersive, amphiphilic, hydrophobic, hydrophilic, oleophobic, oleophilic, anti-microbial, flame-retardant, anti-viral, anti-reflective, super-reflective, infra-red absorptive, and conductive. It may impart strength or other mechanical properties. It may impart the ability to crosslink, which in turn can lead to three-dimensional printed objects having improved mechanical properties such as strength.

In one useful embodiment the functional component is a moiety that imparts colour, anti-microbial properties, conductive properties, flame-retardant properties, hydrophilic properties, hydrophobic properties, or hydrogen bonding properties, or strength properties.

The minor monomer may be a dye, an anti-microbial molecule, a conductive molecule, a flame-retardant molecule, a hydrophilic molecule, a hydrophobic molecule or a hydrogen bonding molecule. The minor monomer may include a reactive double bond that imparts strength or other mechanical properties. In addition to or instead of a reactive double bond, it is also envisaged that the minor monomer may include other moieties that provide the ability to crosslink, which in turn can lead to three-dimensional printed objects having improved mechanical properties.

In one preferred embodiment the functional component is a moiety that imparts colour, anti-microbial properties, conductive properties, or flame-retardant properties.

The minor monomer may be a dye, an anti-microbial molecule, a conductive molecule, or a flame-retardant molecule.

In one such preferred embodiment the functional component is a moiety that imparts colour. The minor monomer can therefore be considered as a dye. This provides a straightforward route to the manufacture of coloured objects by 3D printing, with the benefit that the object is coloured throughout.

In addition, a plurality of different particulate materials can be provided, each having a different colour dye, and these materials can be mixed together before 3D printing to create different colours and shades. For example, a first particulate material can be provided where the minor monomer includes a functional moiety that is a blue dye and a second particulate material can be provided where the minor monomer includes a functional moiety that is a yellow dye and these two particulate materials can be blended in different ratios to achieve different shades of green.

The invention therefore provides, in a second aspect, a kit comprising two or more different particulate materials according to the first aspect, where each particulate material has a minor monomer that includes a functional moiety that is a dye and where each dye is a different colour. In one embodiment, the kit comprises three different particulate materials, one having a blue dye, one having a yellow dye and one having a red dye. The materials in such a kit can then be blended according to RYB colour mixing. In another embodiment, the kit comprises four different particulate materials, one having a cyan dye, one having a magenta dye, one having a yellow dye and one having a black dye. The materials in such a kit can then be blended according to CMYK colour mixing.

In another preferred embodiment the functional component is a moiety that imparts the ability to crosslink. This may be a reactive double bond or may be one or more other moieties that provide the ability to crosslink.

In general, in this embodiment the particles are provided with active functional groups on the outer shell that enable them to react and crosslink during 3D printing such as PBF. This then has the benefit of being able to yield to three-dimensional printed objects that are crosslinked, and which as a consequence have improved mechanical properties.

As the skilled person will be aware, crosslinking occurs through a variety of routes. Non-limiting examples are:
1) reactive double bonds (e.g. vinyl groups) being present in the pendant groups of a polymer chain
2) hydrogen backbiting
3) epoxide-alcohol reactions
4) acid-alcohol reactions.

Double bonds (e.g. pendant vinyl groups) can react with each other, or possibly other groups in a polymer chain to link two chains, and this process continues so that a network of bonded polymer chains forms. Crosslinking can also form through different reactions such as hydrogen ‘backbiting’, this is when a mid-chain radical from an active polymer chain nucleophilicly attacks another polymer chain, thereby linking the two polymer chains together. The reaction between an epoxide and alcohol moieties can lead to crosslinking. This occurs when one segment of the polymer has an epoxide which is opened by an alcohol group. This reaction can create a bond between two polymer chains, which can lead to a crosslinked network. The reaction between an acid and alcohol moieties can also lead to crosslinking. This occurs when one segment of the polymer has an acid group which reacts with an alcohol group. This reaction can create a bond between two polymer chains, which can lead to a crosslinked network.

In addition, therefore, in a third aspect, the invention provides a kit comprising two or more different particulate materials according to the first aspect, wherein each minor monomer includes a functional moiety that imparts crosslinking, wherein there is a first particulate material whereby the minor monomer includes a crosslinking functional moiety, and wherein there is a second particulate material whereby the minor monomer includes a crosslinking functional moiety, where the first and second particulate materials are different. The crosslinking functional moiety in the first particulate material is able to crosslink with the crosslinking functional moiety in the second particulate material. Any of the above-mentioned crosslinking routes may be used, or other crosslinking routes as known in the art.

These materials can be 3D printed together, and when the laser sintering process occurs, crosslinking will occur between the crosslinking functional moieties (e.g. alcohol and epoxide groups; or alcohol and acid groups), resulting in a 3D printed product composed of a crosslinked network. In one embodiment, these two different particulate materials are mixed together before 3D printing.

In some embodiments it is preferred that the polymeric shell of the first particulate material is not the same as the polymeric shell of the second particulate material. These may differ due to the major monomer being different and/or the minor monomer being different. In one embodiment, the crosslinking functional moiety in the first particulate material is different from the crosslinking functional moiety in the second particulate material.

It may be that the crosslinking functional moiety in each particulate material is a reactive double bond, and the first and second particulate materials are different due to (i) a different polymeric core and/or (ii) a different major monomer and/or a (iii) a different minor monomer but where both minor monomers include a reactive double bond.

It may be that the crosslinking functional moiety in the first particulate material is an alcohol, and the crosslinking functional moiety in the second particulate material is an epoxide or an acid. This may be the only difference between the particulate materials, or they may additionally differ due to (i) a different polymeric core and/or (ii) a different major monomer and/or a (iii) a different polymerizable group in the minor monomer.

The invention provides, in a fourth aspect, a method of manufacturing particulate material according to the first aspect. The method comprises:
i) providing a thermoplastic polymer in particulate form;
ii) providing a major monomer and a minor monomer, as defined in the first aspect; and then
iii) carrying out polymerisation of the major monomer and the minor monomer, so as to form a polymeric shell that coats the particulate thermoplastic polymer.

The skilled person will appreciate that the thermoplastic polymer in particulate form as provided in step i) will form the thermoplastic polymeric core of the product according to the first aspect.

In one embodiment, step iii) is carried out using free radical polymerisation or dispersion polymerisation.

In one embodiment, step iii) is carried out using polymerisation, e.g. dispersion polymerisation or free radical polymerisation, in supercritical carbon dioxide (scCO₂). This approach allows for a scalable and versatile one-pot reaction, which yields dry functional materials. scCO₂ is ‘green’ because it is non-toxic, non-flammable, and can potentially be recovered and reused. This technique also yields a dry free-flowing polymer powder, thereby avoiding the need for energy-intensive purification and drying steps which are normally associated with dispersion polymerisations.

The invention provides, in a fifth aspect, a method of manufacturing a three-dimensional object, where the method comprises:
a) providing particulate material as defined in the first aspect;
b) depositing the particulate material; and
c) selectively fusing the deposited particulate material;
   so as to obtain a three-dimensional object.

The depositing step may, for example, comprise depositing the material on a surface, such as a build platform.

Steps b) and c) may be repeated as required. Therefore, it may be that successive layers of particulate material are deposited and fused, with each subsequent layer being placed on the previously fused layer(s). This is of course standard and well known in 3D printing techniques such as Multi Jet Fusion (MJF) and Selective Laser Sintering (SLS). For example, when a build platform is used, after step c) the build platform lowers and then another layer is deposited (step b)) and fused (step c)) on top.

Thus, the steps b) and c) can be repeated as many times as necessary to obtain the three-dimensional object in the desired shape and size.

Computerised control of the steps may be used to achieve the desired shape and size. A CAD file may provide the predetermined pattern for sintering.

The steps b) and c) can, in one embodiment, be carried out by using 3D printing techniques, such as Multi Jet Fusion (MJF), Selective Laser Sintering (SLS), or electrophotography-based additive manufacturing. In one embodiment it may be carried out using a selective deposition-based additive manufacturing process using an electrostatographic engine.

In a sixth aspect, the invention also provides the use of particulate material according to the first aspect to impart one or more of the following properties to a three-dimensional product: colour, anti-static, hydrogen bonding, electro-dispersive, amphiphilic, hydrophobic, hydrophilic, oleophobic, oleophilic, anti-microbial, flame-retardant, anti-viral, anti-reflective, super-reflective, infra-red absorptive, conductive, and strength. In one embodiment, the particulate material is used to form the three-dimensional product by a powder bed fusion (PBF) 3D printing technique, such as Multi Jet Fusion (MJF) or Selective Laser Sintering (SLS).

A benefit of the present invention is that the functional effect is consistently provided throughout the 3D printed product. This is because the polymeric shell that coats the polymeric core includes the minor monomer, which provides functionality due to its functional component. The functional component remains available in the polymeric shell that is formed from the co-polymer of the major monomer and the minor monomer. Thus, each polymeric particle that is 3D printed is provided with this functionality.

### DETAILED DESCRIPTION OF THE INVENTION

The present invention provides a new route to imparting desired end characteristics into a 3D printed object.

In one embodiment, the particulate material of the present invention is suitable for use in a powder bed fusion (PBF) 3D printing technique. PBF techniques include Multi Jet Fusion (MJF), Selective Laser Sintering (SLS), Direct Metal Laser Sintering/Selective Laser Melting (DMLS/SLM), and Electron Beam Melting (EBM). In particular, Multi Jet Fusion (MJF) and Selective Laser Sintering (SLS) both belong to the powder bed fusion family.

In such processes, 3D objects are built by selectively thermally fusing (sintering) polymeric particulate material, on a layer-by-layer basis, to create the desired shape.

SLS is a laser-based technology. A computer-controlled laser beam selectively binds together the polymeric particles in the powder bed, by raising the powder temperature above the glass transition point. Thus, the laser scans and sinters each cross-sectional layer of the object in turn, until the 3D object is completed.

In MJF a fusing agent is selectively deposited on the polymeric particles in the powder bed in the locations where sintering is desired. This fusing agent promotes the absorption of infrared light. An infrared energy source then passes over the powder bed and fuses the inked areas. Again, this is repeated for each cross-sectional layer of the object in turn, until the 3D object is completed.

In each case the un-sintered powder from the powder bed can be removed and reused.

In one embodiment, the particulate material of the present invention is suitable for use in a powder-based 3D printing process that relies on thermal processing, such as electrophotography-based additive manufacturing. The material of the present invention may be used in a selective deposition-based additive manufacturing process using an electrostatographic engine, e.g. of the type developed by Evolve Additive Solutions Inc. and described in their patent applications, e.g. WO2019/152797A1 and WO2021/003165A1.

The particulate material of the present invention is not limited to use in the above techniques. The skilled person will appreciate that there are several other techniques that could usefully utilise this material, such as: binder jetting, powder coating technology, microinjection moulding, roto-moulding and other polymer molding processes.

### Polymer Core

The polymer core used in the present invention should be made from a thermoplastic polymer that can be provided in granular or powder form.

In general, the core material may be selected from semi-crystalline polymers and amorphous polymers.

In one embodiment, the polymer core has a Tg or Tm that is above 31° C. in the presence of scCO₂. Differential scanning calorimetry (DSC) can be used to determine glass transition temperature (Tg), temperature of crystallisation (Tc), and temperature of melting (Tm). The amount of sample used can be 5 mg per run, and run temperature can be 0° C. to 250° C.

Non-limiting examples of polymer cores that can be contemplated are polymer cores made from a polymer selected from:
polyamides (which may be polylactams, polyphthalamides or polyaramids; in one embodiment the polyamide is aliphatic; in one embodiment the polyamide is nylon; specific examples of useful polyamides include PA11 (poly(ω-undecanamide), PA12 (poly(ω-dodecanamide) and PA6 (poly(caprolactam), and poly(6-aminocaproic acid)),
polyetherketoneketone (PEKK),
acrylonitrile butadiene styrene (ABS),
thermoplastic elastomers (TPE),
polypropylene (PP),
thermoplastic polyurethane (TPU),
polyacrylamide (PAM),
poly methyl methacrylate (PMMA),
polystyrene (PS),
polycarbonates (PC),
polylactic acid (PLA),
polyethylene (PE) or polyethylene chloride (PE-C),
polyethylene oxide (PEO).

In one embodiment the polymer core is made from a polymer formed by ring opening polymerisation (ROP), such as polylactic acid (PLA) or polylactams.

In one embodiment the polymer core is made from a polyamide.

As the skilled person will appreciate, nylon materials—and in particular PA12—are widely used in SLS 3D printing, and in powder bed fusion (PBF) more generally, and therefore the present invention may find particular utility with such materials as the polymer core. However, the present invention is not limited to such materials.

The polymer core may optionally be made from a thermoplastic polymer that includes additives, such as glass filler (glass beads or glass fibres), carbon fibre filler, flame retardant material, and/or aluminium filler. The use of such additives in thermoplastic polymers for 3D printing is known in the art. For example, polyamide 12 filled with glass beads can be used for making objects that have high rigidity and good elongation at break, whilst polyamide 12 filled with both hollow glass beads and carbon fibres can be used for making objects that have excellent temperature-resistance and rigidity, as well as being very light.

The polymeric core makes up 75 wt % or more of the total weight of each particle. In one embodiment, the polymeric core makes up 80 wt % or more of each particle, such as 85 wt % or more or 90 wt % or more. It may be that the polymeric core makes up from 75 to 99 wt % of each particle, such as from 80 to 95 wt %, or from 85 to 90 wt %.

### Polymeric Shell

The polymeric shell is formed from a co-polymer of the major monomer and the minor monomer.

The polymeric shell makes up 25 wt % or less of the total weight of each particle. In one embodiment, the polymeric shell makes up 20 wt % or less of each particle, such as 15 wt % or less or 10 wt % or less. It may be that the polymeric shell makes up from 1 to 25 wt % of each particle, such as from 5 to 20 wt %, or from 10 to 15 wt %.

### Major Monomer

The major monomer comprises a polymerisable group, which is preferably selected from: acrylate, methacrylate, acrylamide, methacrylamide, epoxy, isocyanate (—NCO), and vinyl (e.g., styrene (vinylbenzene) or divinyl benzene). Lactams (e.g. caprolactam), lactides, and carbonates can also be mentioned.

The co-polymer may suitably be formed from 60 wt % or more or 65 wt % or more of the major monomer, such as 70 wt % or more, or 75 wt % or more, or 80 wt % or more; in some preferred embodiments it may be 85 wt % or more, or 90 wt % or more. It may be that the major monomer makes up from 70 to 99 wt % of the co-polymer shell or from 75 to 99 wt % of the co-polymer shell, such as from 80 to 98 wt %, or from 85 to 97.5 wt %.

The major monomer is suitably a monomer that, when polymerised, forms a polymer that has similar thermal properties to the polymeric core.

Thus, it is preferred that the thermal properties of the polymeric shell should be similar to the thermal properties of the polymeric core.

The major monomer is preferably a monomer that, when polymerised, has a Tg that is close to the Tm of the thermoplastic polymer that forms the polymer core. It may be that the difference is no more than 15° C., or no more than 12° C. Preferably the difference is no more than 10° C., e.g. no more than 9° C., such as no more than 7 or 8° C. It is beneficial to have these values relatively close together, because then the copolymer shell and the polymer core can sinter at the same time.

In one embodiment, the major monomer is a monomer that, when polymerised, has a Tg onset that is different from the Tc of the thermoplastic polymer that forms the polymer core. Preferably the difference is more than 10° C., e.g. more than 12° C., such as more than 15° C. This can be useful because by having these values spaced apart the powder bed temperature can be kept high enough so that crystallization is not rapidly induced.

Differential scanning calorimetry (DSC) can be used to determine glass transition temperature (Tg), temperature of crystallisation (Tc), and temperature of melting (Tm). The amount of sample used can be 5 mg per run, and run temperature can be 0° C. to 250° C.

In one embodiment the major monomer is isobornyl methacrylate (IBMA). This is, in particular, a useful major monomer to be used when the polymeric core is PA12. This is because, when polymerised, it has thermal properties similar to PA12, which means the copolymer shell and the polymer core can sinter at the same time, whilst the powder bed temperature can be kept high enough so that crystallization is not rapidly induced. In this regard, the glass transition temperature (Tg) of IBMA is about 170 to 180° C., which is similar to the Tm of PA-12 (about 178 to 180° C.), whilst the Tg onset of IBMA is more than 10° C. from the Tc of PA-12. IBMA is also a useful major monomer to be used when the polymeric core is PA11.

The polymerised form of IBMA, poly isobornyl methacrylate, has appropriate optical properties, because it absorbs the radiation of CO₂ lasers. This is therefore another benefit to using IBMA as the major monomer.

However, the invention is not limited to the use of IBMA. Other monomers that can be mentioned as options for use as the major monomer in the invention include methyl methacrylate, ethyl methacrylate, isobornyl acrylate, methyl acrylate, ethyl acrylate, alpha pinene methacrylate and beta pinene methacrylate. Yet further monomers that can be mentioned as options for use as the major monomer in the invention include 4-bromostyrene, 2,6-diphenylphenol, and 4-chlorophenyl vinyl ketone.

In one embodiment, the major monomer is isobornyl methacrylate or methyl methacrylate or alpha pinene methacrylate or ethyl methacrylate or 4-bromostyrene or 2,6-diphenylphenol or 4-chlorophenyl vinyl ketone.

The table below shows non-limiting examples of possible pairings for the polymer core and the major monomer in the polymeric shell. It will be seen that the respective melting points and transition glass temperatures are close to each other. Thus, these pairings meet the desired thermal properties.

| | | | Tg of |
|---|---|---|---|
| | Tm of | | homopolymer |
| | polymer | | of major |
| Polymer core | core (° C.) | Major monomer | monomer (° C.) |
| PA-12 | 178-180 | isobornyl methacrylate | 170-180 |
| PA-11 | 180-190 | isobornyl methacrylate | 170-180 |
| PA-12 | 178-180 | alpha pinene methacrylate | 168 |
| PA-11 | 180-190 | alpha pinene methacrylate | 168 |
| poly(ethylene) | 141 | 4-bromostyrene | 138 |
| poly(ethylene oxide) | 66 | ethyl methacrylate | 65 |
| poly(6-aminocaproic | 224 | 2,6-diphenylphenol | 224 |
| acid) | | | |
| poly(ethylene | 63 | 4-chlorophenyl vinyl ketone | 63 |
| chloride) | | | |

Thus, in one embodiment, the polymeric core and the major monomer are according to one of the combinations set out in the table above.

In one preferred but non-limiting embodiment, the major monomer is IBMA or alpha pinene methacrylate and the polymeric core is PA-12 or PA-11. For example, the major monomer may be IBMA and the polymeric core may be PA-12 or PA-11.

### Minor Monomer

The minor monomer comprises (i) a polymerisable group; and (ii) a functional component.

The functional component is, in general, a functional moiety. This functional moiety is present in the copolymer. It is found as a repeating unit in the copolymer. It is part of the minor monomer that reacts during polymerisation to form the copolymer, but it is not itself part of the polymerization reaction. The functional component does not react during the polymerization reaction. The functional component could be a functional molecule and/or could be a reactive double bond.

The minor monomer preferably comprises a polymerisable group selected from: acrylate, methacrylate, acrylamide, methacrylamide, epoxy, isocyanate (—NCO), styrene (vinylbenzene), and divinyl benzene. Lactams (e.g. caprolactam), lactides, and carbonates can also be mentioned.

The co-polymer may suitably be formed from 40 wt % or less of the minor monomer, such as 35 wt % or less or 30 wt % or less, or 25 wt % or less, or 20 wt % or less; in some embodiments it may be 15 wt % or less, or 10 wt % or less. It may be that the minor monomer makes up from 1 to 30 wt % or from 1 to 25 wt % of the co-polymer shell, such as from 2 to 20 wt %, or from 2.5 to 15 wt %.

In addition to the above-mentioned polymerisable group, the minor monomer includes a functional component. Thus, the particles according to the invention are not standard core-shell polymer particles-instead the shell has added functionality. It is beneficial to be able to provide the functionality within the minor monomer because this means the functionality is distributed throughout the shell and there is no requirement to add separate additives for achieving functionality such as colour or anti-microbial properties or strength or conductivity or flame retardancy.

In the present invention, a reactive double bond is a double bond that is available for reaction in the co-polymer as formed from the minor monomer and the major monomer. In other words, it is not a double bond that is involved in the polymerisation of the monomer. It is a further double bond, in addition to any double bond used in propagation, that is available for reaction after the polymer has been formed.

The skilled person will appreciate that a functional component is a functional moiety that has a known useful property, e.g. colour or anti-microbial properties or flame retardancy or conductivity. The minor monomer can therefore be considered to be an active molecule with functional characteristics. By including the additional functional moiety in the minor monomer, according to the claimed invention, each polymeric particle that is 3D printed is provided with this functionality. This is beneficial in terms of ensuring that the property (functional effect) is consistently provided throughout the 3D printed product.

The functional component is, in one embodiment, a dye. Therefore, the functionality provided is colour. In other embodiments, however, other functional components are contemplated. Other functional components that are contemplated may have one or more of the following properties: anti-static, hydrogen bonding, electro-dispersive, amphiphilic, hydrophobic, hydrophilic, oleophobic, oleophilic, anti-microbial, flame-retardant, anti-viral, anti-reflective, super-reflective, infra-red absorptive, and conductive. Strength and other mechanical properties can also be considered.

For example, a hydrophobic functional moiety could be included in the minor monomer, and the functionality provided is water-repellency and/or water-resistance.

In one useful embodiment the minor monomer could contain a functional moiety that is a dye, an anti-microbial functional moiety, a conductive functional moiety, a flame-retardant functional moiety, a hydrophilic functional moiety, a hydrophobic functional moiety or a hydrogen bonding functional moiety.

The minor monomer may include a reactive double bond that imparts strength or other mechanical properties. It is also envisaged that the minor monomer may alternatively or additionally include other moieties that provide the ability to crosslink (crosslinking functional moieties), which in turn can lead to three-dimensional printed objects having improved mechanical properties, such as strength.

In one preferred embodiment the minor monomer could contain a functional moiety that is a dye, an anti-microbial functional moiety, a conductive functional moiety, or a flame-retardant functional moiety.

A reactive double bond (or other crosslinking moiety) may be included in addition to, or as an alternative to, any other functional moiety. Including a reactive double bond has been found to improve the strength of the resulting 3D printed object. In this regard, a reactive double bond is a double bond that is available for reaction in the co-polymer as formed from the minor monomer and the major monomer. For example, it is envisaged that there could be a functional moiety that is a dye and also a reactive double bond (or other crosslinking moiety). This could provide a 3D printed object that is coloured and has good mechanical properties, e.g. strength.

### Functional Molecule: Dyes

In one embodiment, the minor monomer comprises (i) a polymerisable group, and (ii) a functional moiety that is a dye.

When a dye is present as the functional moiety, the dye may suitably be any organic dye.

Examples of dyes that can be considered include azo dyes and anthraquinone dyes.

Disperse dyes are well known in the art, and can be azo or anthraquinone based, for example Disperse Red 1, Disperse Red 9, Disperse Red 11, Disperse Yellow 3, Disperse Yellow 26, Disperse Yellow 54, Disperse Blue 1, Disperse Blue 3, Disperse Blue 14.

Solvent Yellow 1 (Aniline Yellow), Solvent Yellow 7, Solvent Yellow 14 can also be usefully mentioned.

The skilled person will appreciate that a group that is present on the dye can be used to assist in the synthesis of the minor monomer (in which there is both the dye and a polymerisable group present). For example, a dye that includes a primary alcohol group can be useful for ease of synthesising the minor monomer when it comprises a methacrylate or acrylate group. In this regard, in one embodiment, the dye has a primary alcohol group, and the polymerisable group is a methacrylate moiety that is added by using methacrylic acid or methacryloyl chloride or methyl methacrylate, or the polymerisable group is an acrylate moiety that is added by using acrylic acid or acryloyl chloride or methyl acrylate.

Other groups might of course be present on the dye, and the person skilled in the art can devise a suitable synthesis to obtain a minor monomer in which there is both the dye and a polymerisable group present.

The dye should preferably not be too large, because this could hinder its addition onto the polymer chain.

In one embodiment the dye has a molecular weight of 350 g/mol or less, such as 325 g/mol or less, e.g. 300 g/mol or less.

As the skilled person will appreciate, when provided in the form of the minor monomer the dye's colour properties may change because of the additional polymerisable group, e.g. methacrylate group. Time dependent density functional theory calculations can be used to determine the effect of this additional group on the colour and intensity of the dye molecule. In some cases, the addition of the polymerisable group, e.g. methacrylate group, may enhance the dye characteristics in terms of desired shade or brightness.

It is preferred that the dye has a reactive functional group that allows the formation of the minor monomer, which as noted above also includes a polymerisable group. Thus the minor monomer is suitably formed by reaction between (A) a dye molecule having a reactive functional group A and (B) a second molecule that includes a polymerisable group and a reactive functional group B, whereby the reactive functional groups A and B react together.

It is preferred that the dye does not have any other reactive functional groups that could interfere with the synthesis of the minor monomer or with the polymerisation of the minor monomer with the major monomer.

### Functional Molecule: Anti-Microbial Molecule

In one embodiment, the minor monomer comprises (i) a polymerisable group, and (ii) a functional moiety that is anti-microbial.

When an anti-microbial moiety is present as the functional component, the anti-microbial molecule may be a moiety that prevents or inhibits the attachment of microbes to a surface and/or may be a moiety that is toxic to microbes. In a preferred embodiment, the functional moiety prevents or inhibits the attachment of microbes to a surface.

The microbes may in particular be microorganisms that cause diseases or infections. In one embodiment, the microbes are bacteria or fungi, e.g. yeast.

It may, for example, be that the microbes are bacteria selected from: Pseudomonas aeruginosa, Staphylococcus aureus and Escherichia coli (including uropathogenic Escherichia coli) and/or fungi selected from: Candida albicans, Candida glabrata, Chaetomium globosum and Colletotrichum gloeosporioides

The skilled person will be aware of biologically active monomers that incorporate terpenes, terpenoids, terpenoid alcohols, phenylpropanoids (e.g. cinnamic aldehydes and stilbenoids), and/or organic acids, each of which can have anti-microbial activity.

In particular, the minor monomer may usefully be an acrylate or methacrylate of a terpene, terpenoid, terpenoid alcohol, phenylpropanoid or organic acid. In one embodiment, the minor monomer may be an acrylate or methacrylate of a monoterpene, monoterpenoid, monoterpenoid alcohol, phenylpropanoid (e.g. cinnamic aldehyde) or C3-24 organic acid (e.g. lactic acid, oleic acid). In one embodiment the terpene or terpenoid is one with a general formula of C₁₀H₁₆.

Examples of minor monomers that can be used are bornyl (meth)acrylate, cinnamyl (meth)acrylate, myrtenol (meth)acrylate, neryl (meth)acrylate, oleic acid (meth)acrylate, and lactic acid (meth)acrylate.

The major monomer may, for example, be IBMA. It may be that the co-polymer as formed is, for example, p (IBMA-terpene (meth)acrylate) or p (IBMA-organic acid (meth)acrylate). This co-polymer may, for example, be used with a polymeric core that is PA-12 or PA-11.

### Functional Molecule: Conductive Molecule

In one embodiment, the minor monomer comprises (i) a polymerisable group, and (ii) a conductive functional moiety.

The skilled person will be aware of conductive polymers, such as poly(fluorene)s, polyphenylenes, polypyrenes, polyazulenes, polynaphthalenes, poly(pyrrole)s (PPY), polycarbazoles, polyindoles, polyazepines, polyanilines (PANI), poly(thiophene)s (PT), poly(3,4-ethylenedioxythiophene) (PEDOT), poly(p-phenylene sulfide) (PPS), poly(acetylene)s (PAC), poly(p-phenylene vinylene) (PPV).

The minor monomer may itself be one of these conductive polymers or may comprise one of these conductive polymers. Alternatively, the minor monomer may include a functional group such that, when the minor monomer reacts with the major monomer, the co-polymer as formed includes of these conductive polymers.

In one embodiment, the minor monomer comprises a functional moiety which is thiophene or 3,4-ethylenedioxythiophene. In one embodiment, the minor monomer comprises PEDOT.

In one embodiment, the co-polymer as formed includes poly (3,4-ethylenedioxythiophene) polystyrene sulfonate (PEDOT:PSS). PEDOT:PSS is known to be a conductive polymer.

It may be that the co-polymer as formed is PEDOT:P(SS-[monomer]), for example PEDOT:P(SS-IBMA). This co-polymer may, for example, be used with a polymeric core that is PA-12 or PA-11.

The method of the fourth aspect may be used to produce polymeric particles based on a core of PA-12 or PA-11 and with a polymeric shell that is formed from a co-polymer which is PEDOT:P(SS-IBMA).

This would result in conductive PA-12 or PA-11 based particles which would be suitable for use in a powder bed fusion (PBF) 3D printing technique.

In one embodiment, step iii) of this method of the fourth aspect is carried out using polymerisation in supercritical carbon dioxide (scCO₂).

The following reaction scheme may be used to form the co-polymer PEDOT:P(SS-IBMA) and can be used to form a polymeric shell that coats a particulate thermoplastic polymer:

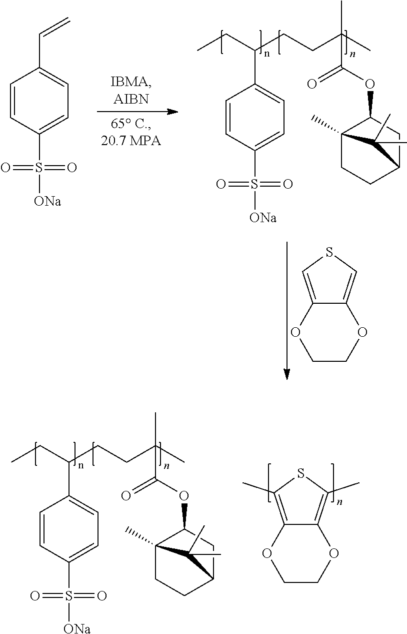

### Functional Molecule: Flame-Retardant Molecule

In one embodiment, the minor monomer comprises (i) a polymerisable group, and (ii) a flame-retardant functional moiety.

The skilled person will be aware of flame-retardant chemicals, such as organohalogen compounds and organophosphorus compounds, and organic compounds that include both phosphorus and a halogen. They include: 9,10-dihydro-9-oxa-10-phosphaphenanthrene-10-oxide (DOPO), triphenyl phosphate, resorcinol bis(diphenylphosphate), bisphenol A diphenyl phosphate, tricresyl phosphate; dimethyl methylphosphonate, aluminium diethyl phosphinate, decabromodiphenyl ether (decaBDE), decabromodiphenyl ethane, brominated polystyrenes, brominated carbonate oligomers, brominated epoxy oligomers, tetrabromophthalic anyhydride, tetrabromobisphenol A, hexabromocyclododecane; tris (2,3-dibromopropyl) phosphate, tris (1,3-dichloro-2-propyl)phosphate, and tetrakis (2-chlorethyl)dichloroisopentyldiphosphate. Boron-containing compounds are also known as flame-retardants.

The minor monomer may itself be one of these flame-retardant chemicals or may comprise one of these flame-retardant chemicals. Alternatively, the minor monomer may include a functional group such that, when the minor monomer reacts with the major monomer, the co-polymer as formed includes of these flame-retardant chemicals.

The skilled person will be aware that it is known in the art to incorporate a flame retarding functionality into a polymer.

In one embodiment, the minor monomer comprises a functional moiety that is 9,10-dihydro-9-oxa-10-phosphaphenanthrene-10-oxide (DOPO).

For example, the flame-retardant chemical DOPO can be modified to add amine groups which can then be reacted with an organic acid to provide acrylate or methacrylate functionality. In one embodiment, the DOPO can be modified to add amine groups which can then be reacted with lactic acid to create P (lactic acid-DOPO diamine).

By providing this (meth)acrylate functionality it can directly copolymerise with a major monomer such as IBMA.

The method of the fourth aspect may be used to produce polymeric particles based on a core of PA-12 or PA-11 and with a polymeric shell that is formed from a co-polymer which is P(IBMA-DOPO acrylamide).

This would result in flame-retardant PA-12 or PA-11 based particles which would be suitable for use in a powder bed fusion (PBF) 3D printing technique.

In one embodiment, step iii) of this method of the fourth aspect is carried out using polymerisation in supercritical carbon dioxide (scCO₂).

The following reaction scheme may be used to form the co-polymer P(IBMA-DOPO acrylamide) and can be used to form a polymeric shell that coats a particulate thermoplastic polymer:

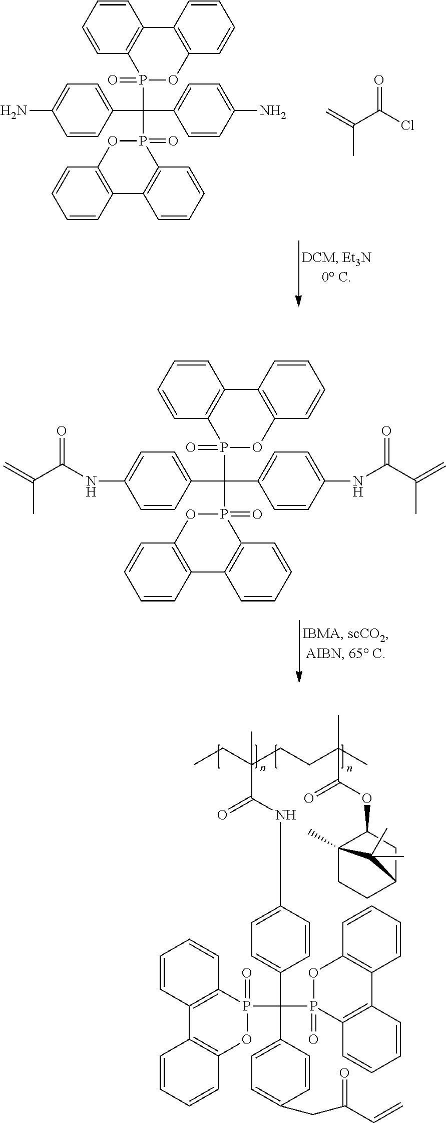

### Functional Molecule: Hydrophilic Molecule

In one embodiment, the minor monomer comprises (i) a polymerisable group, and (ii) a hydrophilic functional moiety.

The skilled person will be aware of hydrophilic molecules and hydrophilic polymers.

Examples of hydrophilic polymers include polyethylene glycol and polyethylene glycol ethers; polyamides; polyacrylamides; polyvinyl alcohol; and polyvinylpyrrolidone.

The minor monomer may itself a hydrophilic polymer or may comprise a hydrophilic polymer. Alternatively, the minor monomer may include a functional group such that, when the minor monomer reacts with the major monomer, the co-polymer as formed includes a hydrophilic polymer.

In one embodiment, the co-polymer as formed includes poly (ethylene glycol) methacrylate (PEGMA). PEGMA is a polymer that is well known for being hydrophilic and its hydrophilicity can be tailored by changing the chain length of the PEGMA polymer.

It may be that the co-polymer as formed is a block copolymer P (monomer-PEGMA), for example P(IBMA-b-PEGMA). This co-polymer may, for example, be used with a polymeric core that is PA-12 or PA-11.

The method of the fourth aspect may be used to produce polymeric particles based on a core of PA-12 or PA-11 and with a polymeric shell that is formed from a co-polymer which is P(IBMA-b-PEGMA).

This would result in hydrophilic PA-12 or PA-11 based particles which would be suitable for use in a powder bed fusion (PBF) 3D printing technique.

In one embodiment, step iii) of this method of the fourth aspect is carried out using polymerisation in supercritical carbon dioxide (scCO₂).

The following reaction scheme may be used to form the block copolymer of P(IBMA-b-PEGMA) and can be used to form a polymeric shell that coats a particulate thermoplastic polymer:

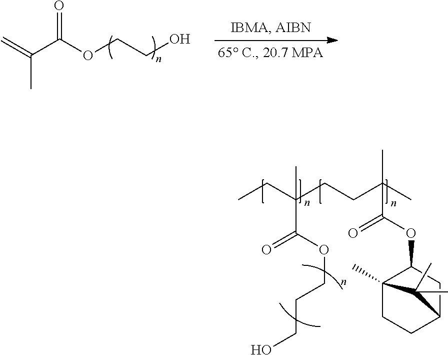

### Functional Molecule: Hydrophobic Molecule

In one embodiment, the minor monomer comprises (i) a polymerisable group, and (ii) a hydrophobic functional moiety.

The skilled person will be aware of hydrophobic molecules and hydrophobic polymers.

Examples of hydrophobic polymers include polyethylene, polystyrene, polyvinylchloride, polytetrafluorethylene, polydimethylsiloxane, polyesters, polyurethanes, and poly (meth)acrylates (e.g. PMA and PMMA).

The minor monomer may itself a hydrophobic polymer or may comprise a hydrophobic polymer. Alternatively, the minor monomer may include a functional group such that, when the minor monomer reacts with the major monomer, the co-polymer as formed includes a hydrophobic polymer.

In one embodiment, the co-polymer as formed includes P(α-pinene methacrylate) or P(β-pinene methacrylate). These are polymers that have been shown to have hydrophobic properties.

It may be that the co-polymer as formed is P(monomer-α/β pinene methacrylate), for example P(IBMA-α/β pinene methacrylate). This co-polymer may, for example, be used with a polymeric core that is PA-12 or PA-11.

The method of the fourth aspect may be used to produce polymeric particles based on a core of PA-12 or PA-11 and with a polymeric shell that is formed from a co-polymer which is P(IBMA-pinene methacrylate), where the pinene methacrylate is α-pinene methacrylate or β-pinene methacrylate.

This would result in hydrophobic PA-12 or PA-11 based particles which would be suitable for use in a powder bed fusion (PBF) 3D printing technique.

In one embodiment, step iii) of this method of the fourth aspect is carried out using polymerisation in supercritical carbon dioxide (scCO₂).

The following reaction scheme may be used to form the P(IBMA—alpha pinene methacrylate), and can be used to form a polymeric shell that coats a particulate thermoplastic polymer:

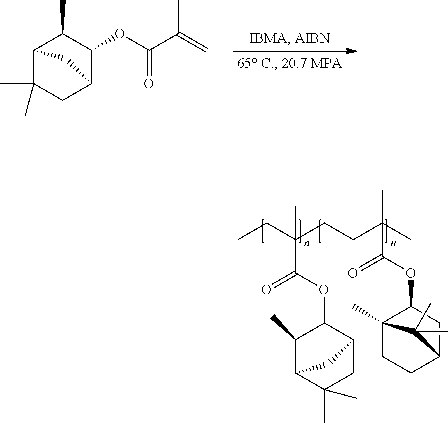

### Functional Molecule: Hydrogen Bonding Molecule

In one embodiment, the minor monomer comprises (i) a polymerisable group, and (ii) a hydrogen bonding functional moiety.

The skilled person will be aware of molecules that can undergo hydrogen bonding and polymers that can undergo hydrogen bonding.

Examples of polymers that can undergo hydrogen bonding include polyamides and poly (meth)acrylates.

The minor monomer may itself a polymer that can undergo hydrogen bonding or may comprise a polymer that can undergo hydrogen bonding. Alternatively, the minor monomer may include a functional group such that, when the minor monomer reacts with the major monomer, the co-polymer as formed includes a polymer that can undergo hydrogen bonding.

In one embodiment, the co-polymer as formed includes poly (2-hydroxyethyl methacrylate) (PHEMA). PHEMA can readily undergo hydrogen bonding.

It may be that the co-polymer as formed is P (monomer-HEMA), for example P(IBMA-HEMA). This co-polymer may, for example, be used with a polymeric core that is PA-12 or PA-11.

The method of the fourth aspect may be used to produce polymeric particles based on a core of PA-12 or PA-11 and with a polymeric shell that is formed from a co-polymer which is P(IBMA-HEMA).

This would result in PA-12 or PA-11 based particles which would undergo hydrogen bonding and would be suitable for use in a powder bed fusion (PBF) 3D printing technique.

In one embodiment, step iii) of this method of the fourth aspect is carried out using polymerisation in supercritical carbon dioxide (scCO₂).

The following reaction scheme may be used to form the P(IBMA-HEMA), and can be used to form a polymeric shell that coats a particulate thermoplastic polymer:

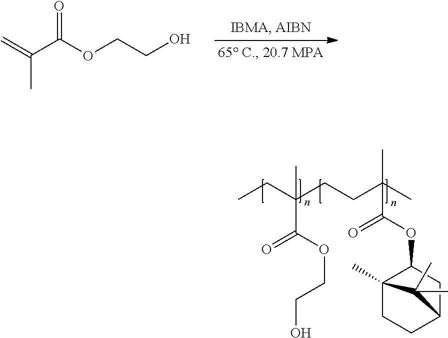

### Reactive Double Bond or Other Crosslinking Functional Moiety

In one embodiment, the minor monomer comprises (i) a polymerisable group, and (ii) a moiety that provides the ability to crosslink (a crosslinking functional moiety). The moiety may provide the ability to crosslink with itself, e.g. via a reactive double bond (such as a vinyl group) or it may provide the ability to crosslink with another group (e.g. an epoxide may be provided that can crosslink with an alcohol, or vice versa).

It is believed that improved mechanical properties, e.g. in terms of strength, are achieved by causing subsequent crosslinking between particles. This may, for example, occur during the preparation of the three-dimensional object, e.g. during SLS or another 3D printing process. It is therefore functionally beneficial to include a crosslinking functional moiety. This can lead to a 3D printed object having improved strength or other improved mechanical properties.

As the skilled person will be aware, crosslinking occurs through a variety of methods. Non-limiting examples are:
1) reactive double bonds (e.g. vinyl groups) being present in the pendant groups of a polymer chain
2) hydrogen backbiting
3) epoxide-alcohol reactions
4) acid-alcohol reactions.

Double bonds (e.g. pendant vinyl groups) can react with each other, or possibly other groups in a polymer chain to link two chains, and this process continues so that a network of bonded polymer chains forms. Crosslinking can also form through different reactions such as hydrogen ‘backbiting’, this is when a mid-chain radical from an active polymer chain nucleophilicly attacks another polymer chain, thereby linking the two polymer chains together. The reaction between an epoxide and alcohol moieties can lead to crosslinking. This occurs when one segment of the polymer has an epoxide which is opened by an alcohol group. This reaction can create a bond between two polymer chains, which can lead to a crosslinked network. The reaction between an acid and alcohol moieties can also lead to crosslinking. This occurs when one segment of the polymer has an acid group which reacts with an alcohol group. This reaction can create a bond between two polymer chains, which can lead to a crosslinked network.

In one embodiment, the minor monomer comprises (i) a polymerisable group, and (ii) a reactive double bond. In this regard, a reactive double bond is a double bond that is available for reaction in the co-polymer as formed from the minor monomer and the major monomer.

For example, the minor monomer may be allyl methacrylate or N-allyl methacrylamide or allyl acrylate.

Advantageously, it has been determined that the inclusion of a reactive double bond improves the strength of the resultant 3D printed object. Both the break force and Young's modulus have been found to be higher. Without being bound by theory, it is believed that these improved properties are due to subsequent crosslinking between particles. This may, for example, occur during the preparation of the three-dimensional object, e.g. during SLS or another 3D printing process. The reactive double bond is a crosslinking functional moiety.

The mechanical properties could be further improved through post-processing crosslinking, which could be done by adding a heat-based initiator to the particulate material when printing.

Post synthesis reactions utilizing the double bonds on the outer surface could also be considered, to introduce new functionalities to the polymer.

### Kits

When the functionality provided is colour, it is a beneficial feature of the present invention that a range of colours and shades for the 3D object can be accessed. Due to the colour (dye) being provided as an attached functionality in the coating on each of the polymer particles, two or more different types of polymer particles in terms of their colour can be mixed together. The colours and the ratios of the different colours can be varied in order to achieve different colours and shades.

Thus, a kit can be provided comprising two or more different particulate materials according to the first aspect, where each particulate material has a minor monomer with a functional moiety that is a dye and where each dye is a different colour. In one embodiment, the kit comprises three different particulate materials, one having a blue dye, one having a yellow dye and one having a red dye. The materials in such a kit can then be blended according to RYB colour mixing. In another embodiment, the kit comprises four different particulate materials, one having a cyan dye, one having a magenta dye, one having a yellow dye and one having a black dye. The materials in such a kit can then be blended according to CMYK colour mixing.

In addition, a kit can be provided comprising two or more different particulate materials according to the first aspect, wherein each minor monomer includes a functional moiety that imparts crosslinking, wherein there is a first particulate material whereby the minor monomer includes a crosslinking functional moiety, and wherein there is a second particulate material whereby the minor monomer includes a crosslinking functional moiety, where the first and second particulate materials are different. The crosslinking functional moiety in the first particulate material is able to crosslink with the crosslinking functional moiety in the second particulate material.

These materials can be 3D printed together, and when the laser sintering process occurs, crosslinking will occur between the crosslinking functional moieties (e.g. alcohol and epoxide groups), resulting in a 3D printed product composed of a crosslinked network. In one embodiment, these two different particulate materials are mixed together before 3D printing.

In particular, these two types of coated particles can be physically mixed and then printed, e.g. via PBF such as SLS. During the printing the energy provided by the laser is enough to cause the crosslinking functional moieties on the two different particles to react, yielding a crosslinked network.

It is preferred that the polymeric shell of the first particulate material is not the same as the polymeric shell of the second particulate material; these may differ due to the major monomer being different and/or due to the minor monomer being different. In one embodiment, the crosslinking functional moiety in the first particulate material is different from the crosslinking functional moiety in the second particulate material. For example, there may be an alcohol and an epoxide respectively, or there may be an alcohol plus an acid respectively.

It may be that the first particulate material has a minor monomer has a polymerisable group that is a (meth)acrylate. It may be that the second particulate material has a minor monomer has a polymerisable group that is a (meth)acrylate.

In one embodiment, the invention provides a kit comprising two or more different particulate materials according to the first aspect, wherein each minor monomer includes a functional moiety that imparts crosslinking, wherein there is a first particulate material whereby the minor monomer includes a functional moiety that is an alcohol, and wherein there is a second particulate material whereby the minor monomer includes a functional moiety that is an epoxide.

These two types of coated particles can be physically mixed and then printed, e.g. via PBF such as SLS. During the printing the energy provided by the laser is enough to cause the alcohol and epoxide groups to react, yielding a crosslinked network.

It may be that the first particulate material has a minor monomer that includes a functional moiety that is an alcohol, and that includes a polymerisable group that is a (meth)acrylate. For example, hydroxy ethyl methacrylate or hydroxy ethyl acrylate.

It may be that the second particulate material has a minor monomer that includes a functional moiety that is an epoxide, and that includes a polymerisable group that is a (meth)acrylate. For example, glycidyl methacrylate or glycidyl acrylate.

In all the kits of the invention, it may be that the two or more different particulate materials have the same polymeric core. They may differ in terms of one or more feature of the polymeric shell. In one embodiment they may differ only in terms of the functional moiety in the respective minor monomers being different.

### Method of Manufacture

The method of manufacturing particulate material according to the invention comprises:
i) providing a thermoplastic polymer in particulate form;
ii) providing a major monomer and a minor monomer, as defined in the first aspect; and then
iii) carrying out polymerisation of the major monomer and the minor monomer, so as to form a polymeric shell that coats the particulate thermoplastic polymer.

In step i) it will be appreciated that the thermoplastic polymer is the core polymer discussed above. The provision of this type of polymeric material in particulate form is well known in the art; this is the type of material provided for use in 3D printing (e.g. SLS) as a powder.

The polymerisation may, for example, be free radical polymerisation or dispersion polymerisation.

The polymeric shell is formed by reaction of the polymerisable group on the major monomer with the polymerisable group on the minor monomer.

The polymerisation of the major monomer and the minor monomer, so as to form a polymeric shell that coats the particulate thermoplastic polymer, can be carried out in any suitable solvent.

However, it has been determined that supercritical CO₂ (scCO₂) is a particularly suitable solvent system.

This approach allows for a scalable and versatile one-pot reaction, which yields dry functional materials. scCO₂ is ‘green’ because it is non-toxic, non-flammable, and can potentially be recovered and reused. This technique also yields a dry free-flowing polymer powder, thereby avoiding the need for energy-intensive purification and drying steps which are normally associated with dispersion polymerisations.

scCO₂ is also particularly useful as a solvent system because it can swell amorphous regions of the thermoplastic polymer that will form the polymer core, e.g. PA-12, whilst in the supercritical stage; this allows for better adhesion of the outer polymeric shell.

In one embodiment, the thermoplastic polymer (in particulate form), the minor monomer and AIBN may be added to an autoclave and degassed with CO₂ for 30 minutes. The major monomer may be degassed together with the minor monomer and AIBN with CO₂ or may be separately degassed with argon in an autoclave. This autoclave may be used as the reaction vessel and therefore the autoclave can be sealed, and the polymerisation can proceed. A core-shell polymeric powder is obtained. Following this process, the produced core-shell polymeric powder can be processed, e.g. on commercially available powder bed fusion equipment with modified parameter sets.

However, the invention is not limited to the use of scCO₂. Any other polymerisation solvent system, as known in the art, may alternatively be used.

When the minor monomer includes a reactive double bond, it may be beneficial to carry out RAFT dispersion polymerisation in step iii). RAFT agents are well known in the art and control the polymerisation, acting to retard the reaction from crosslinking. Examples of suitable RAFT agents include CPDB (2-cyano-2-propyl benzodithioate) and CPDT (2-cyano-2-propyl dodecyl trithiocarbonate).

### Method of Use

The method of manufacturing a three-dimensional object according to the invention comprises:
a) providing particulate material as defined in the first aspect;
b) depositing the particulate material; and
c) selectively fusing the deposited particulate material;
   so as to obtain a three-dimensional object.

It may be that in step a) two or more different particulate materials are provided, wherein each particulate material includes a dye that is a different colour, and these materials are mixed together before being deposited in step b). The ratios of the different materials can be altered to change the shade of the resulting colour. Therefore, colour mixing is possible, opening up the ability to achieve a wide range of colours and shades by using different ratios of a small number of base colours, based on RYB or CMYK. This is the first colour mixing system for a powder bed fusion 3D printing technique, such as Multi Jet Fusion (MJF) and Selective Laser Sintering (SLS).

The invention also provides the use of particulate material according to the first aspect to impart one or more of the following properties to a three-dimensional product: colour, anti-static, hydrogen bonding, electro-dispersive, amphiphilic, hydrophobic, hydrophilic, oleophobic, oleophilic, anti-microbial, flame-retardant, anti-viral, anti-reflective, super-reflective, infra-red absorptive, conductive, and strength. In one embodiment, the particulate material is used to form the three-dimensional product by a powder bed fusion (PBF) 3D printing technique, such as Multi Jet Fusion (MJF) or Selective Laser Sintering (SLS).

The invention will now be further described with reference to the following non-limiting examples.

### EXAMPLES

### Materials:

Methyl methacrylate (MMA) (99%) was obtained from Kaneka Belgium N.V. Isobornyl methacrylate (IBMA) (>80%) was purchased from Sigma Aldrich. 2,2′-Azobis (2-methylpropionnitrile) (AIBN) was purchased from Fluorochem. CO₂ was purchased from Air Products. Disperse Red 1 methacrylate, Yellow 1 methacrylate, Disperse Blue 3 methacrylate were used as synthesised. Triethylamine, petroleum ether, acetone, chloroform, hexane, and toluene were purchased from Fischersci. Dichloromethane (DCM), ethyl acetate, 4-phenylazophenol, (E)-2-(ethyl (4-((4-nitrophenyl)diazenyl)phenyl)amino) ethan-1-ol, and 1-(dimethylamino)-4-((2-hydroxyethyl) (methyl)amino) anthracene-9,10-dione, were purchased from Sigma Aldrich. Methacryloyl chloride was purchased from Acros Organics, Novozyme 435 was purchased from Novozymes, and PA-12 P2200 was purchased from EOS.

### Characterisation:

The structure of the monomers and polymers was analysed via ¹H NMR (Bruker 400 Ultrashield (400 MHZ NMR)), all samples were dissolved in deuterated chloroform. The ¹H NMR spectra were used to identify the polymer formation, and to calculate the monomer conversion using equation 1.

$$Conversion = \frac{AUCP}{AUCP + 1} \qquad Equation 1$$

In this equation AUCP is the area under the curve of the polymer peak when compared to the area under the curve of the monomer peak. Mn, Mw, and Ð values were obtained for all synthesized polymers via GPC. The values were calculated using dn/dc (refractive index increment) values for each polymer. All measurements were performed on an Agilent 1260 Infinity HPLC using HPLC grade THF as eluent at 40° C. with 2× Agilent PL-gel mixed-c column at 1 mL/min flow rate, connected to a differential refractive index (dRI) and MALLS detector.

DSC was used to detect polymer thermal properties, such as glass transition temperature (Tg), temperature of crystallisation (Tc), and temperature of melting (Tm). The amount of sample used was circa 5 mg per run, and run temperature was 0° C. to 250° C.

SEM was used to determine the size and shape of the discrete monodisperse particles, a Phillips XL30 electron microscope was used. The samples were prepared by adding powder to a carbon tab mounted onto a SEM stub, which were then coated with Platinum for 180 seconds at 12 mA and 2.2 kv using an Emitech SC7640 Sputter coater. An average particle size was calculated by taking the area of 100 particles from a SEM image and finding the average, performed using ImageJ. Laser Diffraction Particle Sizing (LDS) was used to analyse the particle size, performed on a Malvern Mastersizer 3000.

The colour of the polymer powders and printed parts was analysed using a NIX mini colour sensor, yielding CYMK and CIELAB values.

### Example 1: Minor Monomer Synthesis and Characterization

Three novel dye monomers were synthesized for use as the minor monomer in the present invention. These were based on the following dyes: Disperse Red 1, Yellow 1, and Disperse Blue 3. In each case, the minor monomer was provided as the methacrylate form of the dye.

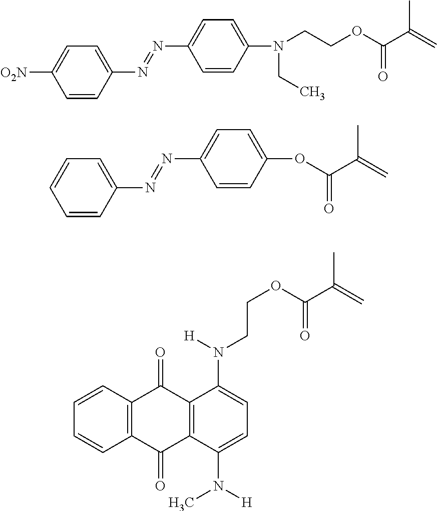

The same synthetic route was employed for the methacrylation of Yellow 1 and Disperse Red 1, namely using methacryloyl chloride, as known in the art. This route is known to be efficient and reliable in the conversion of alcohol groups to methacrylate functionalities.

The synthetic route for the methacrylation of Disperse Blue 3 was altered, because the amine groups in Disperse Blue 3 could react with methacryloyl chloride, potentially yielding significant amounts of by-products. The selectivity issue was resolved through the use of Novozym 435 as catalyst, methyl methacrylate as a comonomer, and toluene as solvent. This synthetic route could be used for Yellow 1 and Disperse Red 1 as well as other dyes.

This reaction procedure can be considered a ‘greener’ substitute. Toluene could also be replaced with a green solvent if desired.

These reactions went to near completion, as shown by 1H NMR. The yields were 92%, 87%, and 91% for DR1MA, Y1MA, and DB3MA respectively. Although the reactions proceeded to completion, there was an average of ˜10% loss of product, as the dye monomers are all purified via column chromatography. The synthesized dye monomers showed good solubility in scCO₂, thereby allowing for their polymerisation via free radical polymerisation in scCO₂.

### Synthesis of Disperse Red 1 Methacrylate (DR1MA):

To a cold solution (0° C.) of (E)-2-(ethyl (4-((4-nitrophenyl)diazinyl)phenyl)amino) ethan-1-ol (3.35 g, 0.0107 mol) in dichloromethane (83.75 mL), trimethylamine (2.43 g, 0.024 mol) was added. To the resulting solution, methacryloyl chloride (1.569 g, 0.159 mol) was added dropwise, and left stirring at 500 rpm for 2 hours. The reaction vessel was connected to a sodium hydroxide bubbler and sealed. The final mixture was quenched with saturated sodium carbonate solution (33 mL). The aqueous layers were extracted with dichloromethane, and the combined organic layers were washed with brine; finally the organic solvent was evaporated under reduce pressure. The resulting red powder was dissolved in petroleum ether/ethyl acetate (40%/60%) and purified through a silica gel column adopting the same eluent mixture to yield a red powder (after solvent evaporation) of disperse red 1 methacrylate.

¹H NMR (400 MHz, CHCl3-d3, δ): 3.55-3.61 (q, J=24 Hz, 2H, CH2), 3.75-3.78 (t, J=12 Hz, 2H, CH2), 4.39-4.42 (t, J=12 Hz, 2H, CH2), 5.62 (S, 3H, CH3), 6.13 (S, 3H, CH3), 6.84-6.86 (d, J=8 Hz, 2H, ArH), 7.93 (d, J=2 Hz, 2H, ArH), 7.91-7.95 (dd, J=16 Hz, 2H, ArH), 8.34-8.37 (dd, J=8 Hz, 2H, ArH)

### Synthesis of Yellow 1 Methacrylate (Y1MA):

To a cold solution (0° C.) of 4-phenyl azophenol (5 g, 0.025 mol) in dichloromethane (200 mL), trimethylamine (5.78 g, 0.057 mol) was added. The reaction vessel was connected to a sodium hydroxide bubbler and sealed. To the solution, methacryloyl chloride (3.711 g, 0.355 mol) was added dropwise, and left stirring at 500 rpm for 4 hours. The solution was quenched with saturated sodium carbonate solution (79 mL). The aqueous layers were extracted with dichloromethane, and the combined organic layers were washed with brine, and the solvent was evaporated. The resulting yellow-brown powder was dissolved in petroleum ether. The solution was purified through a silica gel column with petroleum ether as eluent, and the solvent was then evaporated. The product was then columned through basic alumina with petroleum ether, to yield a yellow powder of yellow 1 methacrylate.

¹H NMR (400 MHZ, CHCl3-d3, δ): 5.82 (S, 3H, CH3), 6.42 (S, 3H, CH3), 7.30-7.32 (d, J=8 Hz, 2H, ArH), 7.49-7.51 (d, J=8 Hz, 2H, ArH), 7.56-7.58 (d, J=8 Hz, 2H, ArH), 7.93-7.95 (d, J=8 Hz, 2H, ArH), 7.99-8.01 (d, J=8 Hz, 2H, ArH)

### Synthesis of Disperse Blue 3 Methacrylate (DB3MA):

1-(dimethylamino)-4-((2-hydroxyethyl) (methyl)amino) anthracene-9,10-dione (0.25 g, 0.0008 mol) was dissolved in toluene (5 mL); Novozyme 435 (0.5 g) and methyl methacrylate (1.02 g, 0.0119 mol) were added to the solution. The solution was raised to 55° C. and put under a vacuum of 0.075 Mpa and was left for 24 hours. The solution was filtered, and washed with dichloromethane, the solvent was then evaporated. The resulting blue powder was purified through a silica gel column with an ethyl acetate eluent, yielding a blue powder of disperse blue 3 methacrylate.

¹H NMR (400 MHZ, CHCl3-d3, δ): 5.54 (S, 3H, CH3), 6.24 (S, 3H, CH3), 7.19-7.21 (d, J=8 Hz, 2H, ArH), 7.70-7.73 (dd, J=8 Hz, 2H, ArH), 8.35-8.37 (dd, J=4 Hz, 2H, ArH), 10.65 (S, NH)

### Example 2: Synthesis of Polymeric Shell as a Coating on Polymer Core

Polymer coatings were formed by polymerising major monomer and minor monomer on the surface of polymer core particles, thereby coating the particles with an outer shell composed of the random copolymer during the polymerisation.

Each of the above-synthesised minor monomers were used. Isobornyl methacrylate (IBMA) was used as the major monomer. PA-12 was used as the polymer core.

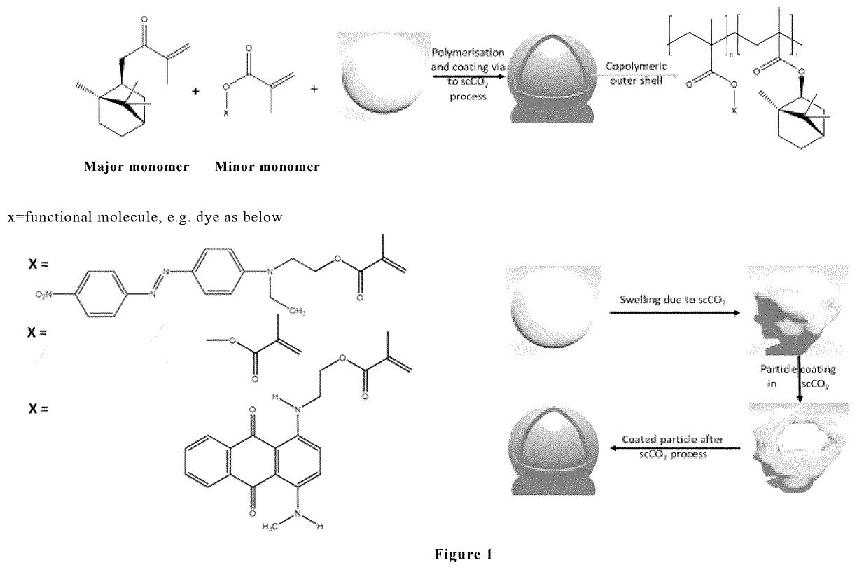

FIG. 1 is an illustrative reaction scheme.

In each case, both a small-scale production and a scale-up were carried out.

Synthesis of p(IBMA-DR1MA) Outer Shell on PA-12 Particles:

PA-12 (10 g or 130 g), IBMA (0.5 g, 0.0022 mol or 19.5 g, 0.0877 mol), DR1MA (0.05 g, 0.1308 mmol or 0.4875 g, 0.0013 mol), and AIBN (0.025 g, 0.1522 mmol or 0.2 g, 0.0012 mol) were degassed in the autoclave for 15 min, by flushing it with CO₂ at a constant pressure between 0.27-0.41 MPa. The key was then shut rapidly, and the pressure was slowly increased to 5.51 MPa, subsequently the temperature was increased to 50° C., and after stabilising the autoclave was pressurized to 13.79 MPa, with subsequent heating to 65° C. Once stable at 65° C. the reaction is pressurized to 20.7 Ma and left stirring at 450 rpm for 24 hours. The autoclave is allowed to cool <30° C. and the CO₂ is vented slowly, and the autoclave is opened to reveal the product.

¹H NMR (400 MHZ, CHCl3-d3, δ): 4.30-4.60 (mp, 1H, CH), 7.90-8.00 (mp, 2H, ArH) (mp, 2H, ArH), 8.30-8.40 (mp, 2H, ArH)

Synthesis of p(IBMA-Y1MA) Outer Shell on PA-12 Particles:

PA-12 (10 g or 130 g), IBMA (0.5 g, 0.0022 mol or 19.5 g, 0.0877 mol), Y1MA (0.05 g, 0.1877 mmol or 0.4875 g, 0.0018 mol), and AIBN (0.025 g, 0.1522 mmol or 0.2 g, 0.0012 mol) were degassed in the autoclave for 15 min, by flushing it with CO₂ at a constant pressure between 0.27-0.41 MPa. The key was then shut rapidly, and the pressure was slowly increased to 5.51 MPa, subsequently the temperature was increased to 50° C., and after stabilising the autoclave was pressurized to 13.79 MPa, with subsequent heating to 65° C. Once stable at 65° C. the reaction is pressurized to 20.7 MPa and left stirring at 450 rpm for 24 hours. The autoclave is allowed to cool <30° C. and the CO₂ is vented slowly, and the autoclave is opened to reveal the product.

¹H NMR (400 MHZ, CHCl3-d3, δ): 4.30-4.60 (mp, 1H, CH), 7.40-7.60 (mp, 2H, ArH) (mp, 2H, ArH), 7.80-8.00 (mp, 2H, ArH) (mp, 2H, ArH)

Synthesis of p(IBMA-DB3MA) Outer Shell on PA-12 Particles:

PA-12 (10 g or 130 g), IBMA (0.5 g, 0.0022 mol or 19.5 g, 0.0877 mol), DB3MA (0.05 g, 0.1877 mmol or 0.4875 g, 0.0013 mol), and AIBN (0.025 g, 0.1522 mmol or 0.2 g, 0.0012 mol) were degassed in the autoclave for 15 min, by flushing it with CO₂ at a constant pressure between 0.27-0.41 MPa. The key was then shut rapidly, and the pressure was slowly increased to 5.51 MPa, subsequently the temperature was increased to 50° C., and after stabilising the autoclave was pressurized to 13.79 MPa, with subsequent heating to 65° C. Once stable at 65° C. the reaction is pressurized to 20.7 MPa and left stirring at 450 rpm for 24 hours. The autoclave is allowed to cool <30° C. and the CO₂ is vented slowly, and the autoclave is opened to reveal the product.

¹H NMR (400 MHZ, CHCl3-d3, δ): 4.30-4.60 (mp, 1H, CH), 7.28 (D, 2H, ArH), 7.73-7.75 (mp, 2H, ArH), 8.34-8.38 (mp, 2H, ArH), 10.65 (S, NH)

### Example 3: Characterisation of the Copolymer Coatings

The random copolymers of IBMA with each of DR1MA, Y1MA and DB3MA were analysed via GPC and 1H NMR. This showed that the copolymers p (IBMA-minor monomer) had formed, because the UV traces matched the dRI trace in the GPC chromatograms.

The conversions for all the synthesized polymers were obtained from the 1H NMR spectra and were similar and in the range of 57%-75%.

The GPC chromatograms elucidated the fact that the molecular weights of all p (IBMA-dye monomer) coatings were above 30,000 Da. Molecular weight greatly affects the thermal properties of amorphous polymers, however at a certain weight the severity of this effect significantly diminishes, and all the synthesized random co-polymers have molecular weights above the plateau influencing the thermal properties of pIBMA, thereby guaranteeing consistent Tg values.

The reactions were performed on the 60 mL and 1 L scale, utilizing the same stoichiometric ratios, yielding analogous results, showing that the polymerisations are scalable. The scalability of the polymerisation is a useful aspect of the synthetic process, because it shows that enough material for commercial 3D printing can be produced in a reasonable time frame.

All the coated PA-12 particles exhibited the appropriate extrinsic and intrinsic properties needed for PBF, e.g. SLS. The intrinsic properties of these polymeric particles are suitable for PBF, e.g. SLS. In this regard, DSC analysis showed as the Tm, Tc, and Tg of all coated PA-12 samples as 175° C., 146° C., and 166° C.-168° C. respectively. The thermal properties ensure that the particles will sinter effectively.

The extrinsic properties of these particles were also appropriate as the particle size increased by 2-4 μm after the coating process, leading to an average particle size ranging from 60-63 μm, confirmed via SEM and LDS analysis.

The fact that the Tg of the random co-polymer coating is quite close (˜7-8° C.) to the Tm of the PA-12, but far from its Tc, ensures that the random copolymer outer shell and the PA-12 can sinter at the same time when exposed to the laser, whilst the powder bed temperature can be kept high enough so that crystallization is not rapidly induced.

The results therefore indicate that these polymeric particles are suitable for PBF, e.g. SLS, printing, and since their extrinsic and intrinsic properties are similar their physical mixing and subsequent multi-material printing should be possible.

### Example 4: SLS Printing of Single Colour-Coated PA-12 Inks

The coated polymeric particles as made in Example 2 were printed via SLS on an EOS Formiga P110. Similar conditions were used for each of the differently coated particles.

Squares were designed (Magics) with dimensions of 5×20×20 mm. The powder of PA-12 coated with p (IBMA-Dye monomer) was sieved through a 200 μm mesh and dried for 1 hour at 100° C. The powders were sintered (EOS Formiga P110) using a powder bed temperature (PBT) of 159° C., Hatching speed (HS) of 2500 mm/s, Hatching distance (HD) of 0.25 mm, and a Laser power (LP) of 14.5 W for PA-12 coated with p (IBMA-Y1MA). PA-12 coated with p (IBMA-DB3MA) was printed with the following conditions: PBT of 159° C., HS of 2200 mm/s, HD of 0.23 mm, and a LP of 15.5 W. PA-12 coated with p (IBMA-DR1MA) was printed with the following conditions: PBT of 159° C., HS of 2500 mm/s, HD of 0.25 mm, and a LP of 14.5 W. The parts were cooled overnight and collected.

Using this approach, a 5×20×20 mm polymer square was built made from PA-12 particles coated with p (IBMA-Y1MA) with minimal warpage (PA-12 standards) and with CMYK and CIELAB values of 3%, 19%, 56%, 0% and 85, 43, 79° 0.29 These values prove that the resulting part is yellow. CMYK and CIELAB are two widely used colour scales, CMYK is often used for colour mixing and CIELAB is the standard colour scale used by the International Commission on Illumination.

A 5×20×20 mm polymer square was also built made from PA-12 particles coated with p (IBMA-DB3MA) with minimal warpage (PA-12 standards). The square built from PA-12 coated with p (IBMA-DB3MA) was blue and had the following CMYK and CIELAB values respectively: 100%, 74%, 0%, 0% and 35, 4, −56°.

A 5×20×20 mm polymer square was also built made from PA-12 particles coated with p(IBMA-DR1MA) with minimal warpage (PA-12 standards) and this was red.

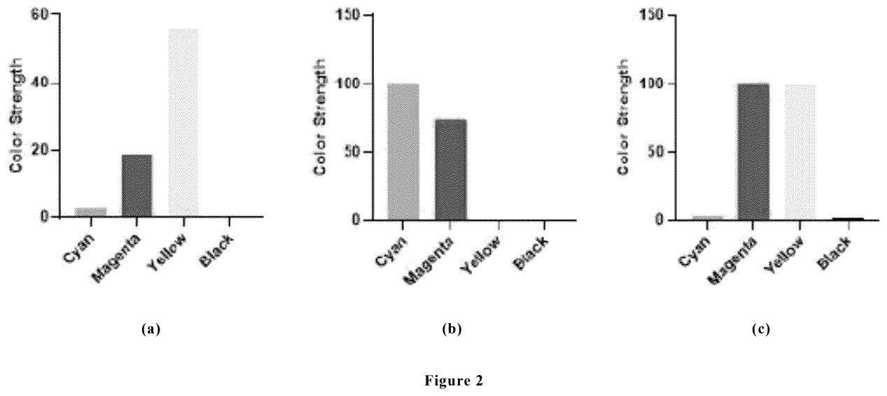

FIG. 2 shows the CYMK values for sintered polymer parts made using each of the three coated polymeric particles. FIG. 2(a) is p(IBMA-Y1MA); FIG. 2(b) is p(IBMA-DB3MA); FIG. 2(c) is p(IBMA-DR1MA).

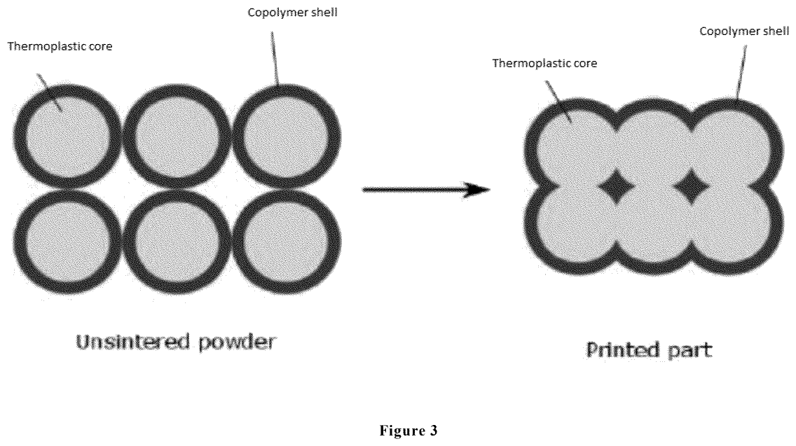

FIG. 3 is a schematic illustration of the core-shell polymeric material when in un-sintered powder form and after being sintered (3D printed).

### Example 5: SLS Printing of Premixed Colour-Coated PA-12 Inks

Physical blends of coated polymeric particles as made in Example 2 were made and then printed via SLS on an EOS Formiga P110. In this regard, the blue and yellow coloured PA-12 powders were physically blended in different ratios, resulting in varying shades of green.

Squares were designed (Magics) with dimensions of 0.1×20×20 mm. Varying ratios of PA-12 coated with P(IBMA-Y1MA) and PA-12 coated with P(IBMA-DB3MA) were physically blended for 1 hour. The resulting green powders were sintered (EOS Formiga P110) using a PBT of 161° C., HS of 2500 mm/s, HD of 0.25 mm, and LP of 15.5 W. The parts were cooled overnight and collected.

The ratios used were 90 wt %/10 wt %, 87.5 wt %/12.5 wt %, and 85 wt %/15 wt % for PA-12 coated with p (IBMA-Y1MA) and PA-12 coated with p (IBMA-DB3MA) respectively. A higher proportion of the yellow PA-12 was used as it has a less intense colour than its blue counterpart. These mixed powders were printed via SLS with a square design (0.1×20×20 mm), yielding green squares.

The CMYK and CIELAB values of the square with the 90/10 ratio were: CMYK (58, 20, 47, 1), CIELAB (64, −20, 4°).

The CMYK and CIELAB values of the square with the 87.5/12.5 ratio were: CMYK (64, 22, 49, 2), CIELAB (61, −23, 2°).

The CMYK and CIELAB values of the square with the 85/15 ratio were: CMYK (67, 21, 48, 2), CIELAB (60, −25, 0°).

The CMYK and CIELAB values prove that by physically blending different ratios of the primary-coloured PA-12 powders, different colours can be obtained and printed in SLS.

### Examples 1-5: Conclusion

It has been shown that it is possible to print with polymer particles in which coloured dyes are part of the polymer structure. This allows wholly coloured structures to be printed, i.e. there is colour throughout, addressing the problem of colour penetration.

The particles can be 3D printed using powder bed fusion (PBF) techniques, such as SLS.

Beneficially, there is very little added cost to printing because:
1. the dye monomer synthesis is economically viable.
2. the same PBF (e.g. SLS) printers can be used.
3. the dye monomer is used in relatively small amounts (e.g. 2.5 wt % of outer shell) reducing the cost of the process.
4. there is also no added production time or increased labour, as the polymeric particles can be processed and printed much like their PA-12 precursor.

Very importantly, this process does not influence the dimensions of the resulting part, because the colour is part of the polymer and is not added during post-processing.

It has also been shown that colour mixing is possible, opening up the ability to achieve a wide range of colours and shades by using different ratios of a small number of base colours, based on RYB or CMYK. This is, to date, the first colour mixing system for SLS 3D printing; beneficially the process needs no special pre-treatment and is easily affordable for industrial use.

### Example 6: Synthesis of Poly Methyl Methacrylate Particles Coated with Poly (Methyl Methacrylate-Allyl Methacrylate)

Polymer coatings were formed by polymerising major monomer and minor monomer on the surface of polymer core particles, thereby coating the particles with an outer shell composed of the random copolymer during the polymerisation.

Methyl methacrylate was used as the major monomer. Allyl methacrylate was used as the minor monomer. Poly methyl methacrylate was used as the polymer core. As in Example 2, the polymer was made via free radical polymerisation in scCO₂. RAFT was used to retard the reaction from crosslinking.

Samples P11 and P12 were produced in a 20 mL base. The conversion of AMA was kept below 60%, in an attempt to avoid crosslinking. GPC results showed that P11 and P12 were reasonably controlled, because the Ð of P12 was 1.3, and that of P11 was 1.7. The T_{g} of both samples was quite similar (˜120° C.), which would be suitable for SLS 3D printing.

The reaction was scaled up using the 60 mL autoclave. P13 was made using the same reaction conditions as for P11 and P12. This polymer, however, was not a free-flowing powder, indicating it was crosslinked. The reaction conditions were then changed for P14 and P15 to avoid the polymer crosslinking; the change was to reduce the molar percentage of AMA from 10% to 5%. This gave free-flowing powders. P14 and P15 had very similar results, apart from the conversion of AMA where P14 had a slightly higher conversion. The T_{g} of both samples was about 130° C., which is about 10° C. higher than the T_{g} of P11 and P12. This is because the molecular weight of P14 and P15 is higher than for P11 and P12.

The reaction was then changed by using the RAFT agent CPDT instead of CPDB. The reaction with CPDT yielded polymers P16-P18, which were all free-flowing white powders. The conversion for samples P16-P18 was quite similar, with the conversion of MMA ranging from 91% to 97% and that of AMA from 30% to 37%. The GPC data suggests that this reaction is reliable, because the Mₙ, M_{w}, and Ð values do not differ by wide margins. One of the positive outcomes of using CPDT is that the Ðs dropped from 2.7 to 1.7 on average. The T_{g} values of P16-P18 were all about 130° C., resembling P14-P15. This is likely because the molecular weights for these samples are alike.

The solubility of the polymers was tested, in order to see if they were branched or crosslinked; all of the polymers except for P13 dissolved readily.

The polymers P11 and P12 were imaged via SEM, revealing that they were composed of particles, which then formed secondary structures. The average particle size obtained from SEM was 4.28 μm. However, SEM analysis of P14 and P15 revealed that these samples were not composed of particles, but agglomerated masses. SEM analysis for P16-18 showed that the polymers were composed of particles that formed secondary structures and the size of the particles was found to be 521 nm.

Polymers P16-P18 appeared to be appropriately suited for PBF, e.g. SLS, for a variety of reasons. One is that the polymers showed the correct intrinsic properties. As they can absorb radiation at the correct wavelength for both CO₂ and UV lasers, the T_{g}s are consistent and high enough to be stable in the powder bed, and the Ðs are not too high. The extrinsic properties are also appropriate, because the particles consistently packed into secondary structures with a particle size of 31.7 μm. The secondary structures then pack into monolayers. From this it can be concluded that the samples P16-P18 could be used for SLS 3D printing, or other PBF printing. These polymers could produce parts with improved mechanical and physical properties due to the fact that chemical bonding could be induced in-situ or in post processing.

It is also envisaged that PA-12 particles coated with poly (IBMA-allyl methacrylate) could be produced, and these particles could be used to 3D print products with improved mechanical and physical properties, such as strength.

TABLE 1

| | Autoclave | | | Conversion | Conversion | Actual | | | |
|---|---|---|---|---|---|---|---|---|---|
| | Base (20 | RAFT | Theoretical | of MMA | of AMA | Mn | | | Tg |
| Polymer | mL) | agent | Mn (KDa) | (%)^{a} | (%)^{a} | (KDa)^{b} | Mw (KDa)^{b} | Ð^{b} | (° C.)^{c} |
| P11 | 20 | CPDB | 22 | 96 | 46 | 33 | 58 | 1.7 | 122 |
| P12 | 20 | CPDB | 23 | 96 | 54 | 16 | 23 | 1.3 | 117.6 |
| P13 | 60 | CPDB | NA | NA | NA | NA | NA | NA | NA |
| P14 | 60 | CPDB | 23 | 96 | 48 | 107 | 290 | 2.7 | 129 |
| P15 | 60 | CPDB | 22 | 94 | 62 | 111 | 299 | 2.6 | 132.7 |
| P16 | 60 | CPDT | 22 | 95 | 37 | 90 | 152 | 1.6 | 130.4 |
| P17 | 60 | CPDT | 22 | 97 | 30 | 97 | 154 | 1.5 | 131.2 |
| P18 | 60 | CPDT | 21 | 91 | 32 | 112 | 196 | 1.7 | 132.1 |

^{a}Calculated from ¹H NMR spectra of the reaction mix.
^{b}Calculated from GPC in THF using a pMMA triple detection.
^{c}Calculated from the first run of DMA.

### Example 7: Mechanical Strength Testing

The p(MMA-AMA) coated particles as made in Example 6 were used to make rectangular bars for tensile strength testing. They were compared against bars made from standard pMMA particles.

The tensile bars were made using solvent casting. The bars were of the same length (2 cm) and their mechanical properties were tested. The bars were all notched at the same position, using the same dimensions. The notches were made to ensure that the bars all snap at the same place, thereby making the data more reliable.

TABLE 2

| Sample | Break Force (MPa) | Young's Modulus (MPa) |
|---|---|---|
| pMMA-pAMA | 35.5 | 4613 |
| pMMA-pAMA | 25.9 | 8354 |
| pMMA-pAMA | 18.9 | 6020 |
| pMMA | 7.1 | 2217 |
| pMMA | 18.7 | 3426 |
| pMMA | 20.8 | 3508 |

The break force required to break the p (MMA-AMA) bars ranged from 18.9-35.5 MPa, and the p (MMA) bars ranged from 7.1-20.8 MPa. Evidently the force required to break the p (MMA-AMA) bars is greater; hence the performance of this material is better than the standard p (MMA) particles.

The Young's modulus for the p (MMA-AMA) bars ranged from 4613-8354 MPa (average: 6329 MPa), and for the p (MMA) ranged from 2217-3508 MPa (average 3050 MPa). The average Young's Modulus for the p (MMA-AMA) bars was therefore two times higher than the standard pMMA bars.

### Example 8: Synthesis of PA-12 Particles Coated with Poly (IBMA-Glycidyl Methacrylate) and PA-12 Particles Coated with Poly (IBMA-2-Hydroxy Ethyl Methacrylate)

This example tested an approach by which some PA-12 particles were coated with an outer shell which contains a minor monomer that contains an alcohol group (2-hydroxy ethyl methacrylate (HEMA)) and some PA-12 particles were coated with an outer shell which contains a minor monomer that contains an epoxide group (glycidyl methacrylate (GMA)).

HEMA has an alcohol moiety which can be used to cause crosslinking when reacted with an epoxide. HEMA has a methacrylate and is soluble in scCO₂, hence it should readily copolymerise with IBMA and form an outer shell on the PA-12 particles. GMA has an epoxide moiety, which should cause crosslinking when exposed to the alcohol moiety from HEMA (when exposed to heat ˜200° C.). It has a methacrylate and is soluble, allowing for the P(IBMA-GMA) copolymeric outer shell to form on PA-12 particles. Both monomers are halogen free.

In this example, PA-12 particles were coated with either P(IBMA-GMA) or P(IBMA-HEMA) respectively, via free radical polymerisation, using scCO₂ as a reaction medium. The same reaction scheme as shown in FIG. 1 was used, but where the minor monomer was instead either:

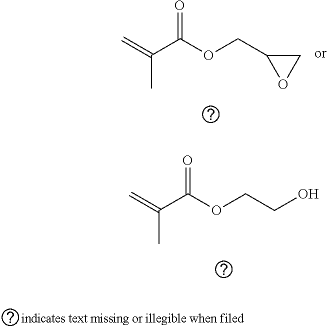

The copolymeric coatings were analysed via 1H NMR and GPC after the coatings were extracted with DCM, and subsequently filtered, dried, and redissolved in the appropriate solvent for analysis.

From ¹H NMR it could be seen that the polymer peaks for each respective polymer had successfully formed for each minor monomer.

Results are shown in Table 3 below:

TABLE 3

| | | Conversion | | | |
|---|---|---|---|---|---|
| | Conversion | of minor | | | |
| | of IBMA | monomer | | Mw | |
| Sample | (%)^{a} | (%)^{b} | Mn (KDa)^{b} | (KDa)^{b} | Ð^{b} |
| PA-12 | 84.4 | 50.9 | 40 | 83 | 2.1 |
| coated with | | | | | |
| P(IBMA- | | | | | |
| HEMA) 1 | | | | | |
| PA-12 | 74.3 | 71.9 | 27 | 42 | 1.5 |
| coated with | | | | | |
| P(IBMA- | | | | | |
| GMA) 1 | | | | | |
| PA-12 | 81.4 | 45.6 | 41 | 9 | 2.2 |
| coated with | | | | | |
| P(IBMA- | | | | | |
| HEMA) 2 | | | | | |
| PA-12 | 78.5 | 59.5 | 26 | 63 | 2.4 |
| coated with | | | | | |
| P(IBMA- | | | | | |
| GMA) 2 | | | | | |

The results show that the synthesis of the P(IBMA-HEMA) and P(IBMA-GMA) coatings were successful, as none of the samples were crosslinked and all contained the desired alcohol and epoxide functionalities respectively.

These two types of coated particles can be physically mixed and then printed, e.g. via SLS. During the printing the energy provided by the laser is enough to cause the alcohol and epoxide groups to react, yielding a crosslinked network.

Initial testing of the coated particles suggests that a tensile bar composed of a mixture of 50 wt % PA-12 coated with P(IBMA-HEMA) and 50 wt % PA-12 coated with P(IBMA-GMA) has improved strength properties compared to a tensile bar composed of 100 wt % PA-12 coated with P(IBMA). Therefore, interparticle crosslinking does appear to occur and this may provide a route to controlling strength properties.

### Examples 6-8: Conclusion

It has been shown that it is possible to obtain polymer particles in which reactive double bonds are part of the polymer structure. This allows stronger 3D printed objects to be prepared.

The particles can be 3D printed using powder bed fusion techniques, such as SLS.

A benefit of the present strategy, in which a co-polymeric outer shell containing free/reactive double bonds is formed on the core polymer particles (e.g. PA-12 particles), is that the reactive double bonds can crosslink in situ during 3D PBF printing, e.g. SLS printing. During sintering, most of the coated particles will melt and a crosslinked polymer network can form in the melt pool, which should be evenly spread throughout the 3D printed product. This is advantageous as it means no gaps will be left which could otherwise lead to stress points in which the 3D printed product has a lower tensile strength than the rest of the 3D printed product.

It is desired for crosslinking to occur during the sintering process and not before. This is because if crosslinking occurs before then each individual particle will be coated with a crosslinked shell, so the strength that comes from having a crosslinked network through the part would not exist as each individual particle would have its own network, hence the mechanical properties of the part would not be improved. What is needed is that the functional groups responsible for the crosslinking are stable enough that they do not react during the reaction or at slightly elevated temperatures. The functional groups must be able to be initiated by heat, so that when the laser sintering process occurs, the crosslinking process will happen in the melt pool, resulting in a 3D printed product composed of a crosslinked network. The present examples show that this can be achieved.

### Example 9: Synthesis of Polymer Core Coated Polymer Shell that has Anti-Microbial Functionality

In a similar manner to that discussed above, polymer coatings were formed by polymerising major monomer and minor monomer on the surface of polymer core particles, thereby coating the particles with an outer shell composed of the random copolymer during the polymerisation. Free radical polymerisation in scCO₂ was used.

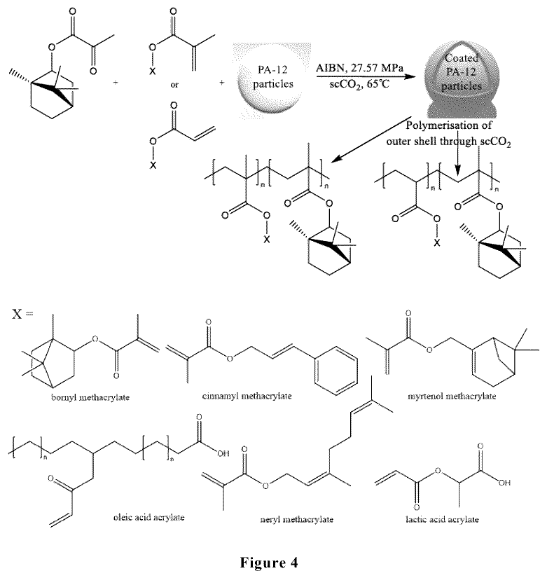

FIG. 4 is an illustrative reaction scheme.

Isobornyl methacrylate (IBMA) was used as the major monomer. PA-12 was used as the polymer core. The minor monomers used were bornyl methacrylate, cinnamyl methacrylate, myrtenol methacrylate, neryl methacrylate, oleic acid acrylate, and lactic acid acrylate. These were chosen due to being (meth)acrylate derivatives of materials known to have biological activity.

The coatings were made with three different concentrations (10, 20, 30 wt % of the outer shell) for each of the minor monomers.

From ¹H NMR it could be seen that the polymer peaks for each respective polymer had successfully formed for each minor monomer and each concentration.

T_{g}, Tₘ and Tₑ were investigated via DSC analysis. In each case, the Tg of the copolymeric coating was similar to the Tm of the PA-12 used as the polymer core. As noted above, it is beneficial to have these values relatively close together, because then the copolymer shell and the polymer core can sinter at the same time.

The detailed results for the 30 wt % products are shown in Table 4 below. Similar results were obtained for the 10 and 20 wt % samples.

TABLE 4

| | co-polymer | M_{D} | M_{w} | | T_{g} | Tₘ | T_{c} |
|---|---|---|---|---|---|---|---|
| Sample | formation | (KDa) | (Kda) | Ð | (° C.) | (° C.) | (C) |
| PA-12 coated | Yes | 25 | 56 | 2.2 | 139.2 | 172.7 | 140.3 |
| with p(IBMA- | | | | | | | |
| bornyl | | | | | | | |
| methacrylate) | | | | | | | |
| 30 wt % | | | | | | | |
| PA-12 coated | Yes | 8 | 44 | 5.6 | 142.0 | 175.6 | 144.2 |
| with p(IBMA- | | | | | | | |
| cinnamyl | | | | | | | |
| methacrylate) | | | | | | | |
| 30 wt % | | | | | | | |
| PA-12 coated | Yes | 19 | 47 | 2.5 | 147.2 | 175.3 | 147.6 |
| with p(IBMA- | | | | | | | |
| neryl | | | | | | | |
| methacrylate) | | | | | | | |
| 30 wt % | | | | | | | |
| PA-12 coated | Yes | 21 | 112 | 5.3 | 142.9 | 171.9 | 143.2 |
| with p(IBMA- | | | | | | | |
| myrtenol | | | | | | | |
| methacrylate) | | | | | | | |
| 30 wt % | | | | | | | |
| PA-12 coated | Yes | 29 | 149 | 5.1 | 147.9 | 176.1 | 149.4 |
| with p(IBMA- | | | | | | | |
| modified oleic | | | | | | | |
| acid acrylate) | | | | | | | |
| 30 wt % | | | | | | | |
| PA-12 coated | Yes | 18 | 69 | 3.9 | 151.2 | 176.4 | 151.7 |
| with p(IBMA- | | | | | | | |
| modified lactic | | | | | | | |
| acid acrylate) | | | | | | | |
| 30 wt % | | | | | | | |

### Example 10: Testing of Anti-Microbial Properties (Anti-Attachment)

To test anti-attachment (anti-microbial) properties for the materials of Example 9, these materials were printed via melt pressing. Melt pressing was chosen as the printing technique because it is analogous to SLS, as it takes the polymer through a similar thermal process, but instead of using a laser it uses heated plates. This means that the material receives the same thermal treatment, but a much smaller amount of material can be used for the test.

The parts printed were discs with a thickness of 1.5 mm and a diameter of 5 mm. These dimensions were chosen as they allow for the discs to be placed into 96 well plates, in which bioassays are frequently performed. The melt pressing involved inserting a sample of each material into a mould with the desired shape, and then pressing this mould between two plates, which were heated slightly above the Tg and Tm of the polymer.

The samples were then tested in bioassays to determine their effect on the surface attachment of the following microbes: P. aeruginosa, C. glabrata, C. gloesporioides and C. globosum. The bioassays tested the activity of the samples against the growth of the microbes. These assays were conducted in triplicate, placing the disc shaped samples in a 96 well plate. The control used was a disc made of 100% PA-12. The attachment of the microbes to the coated samples was compared to the attachment on the PA-12 control, so the PA-12 control has a value of 100% attachment.

Biofilm metabolic activity was measured by the XTT (Sigma-Aldrich) reduction assay. For C. glabrata and P. aeruginosa (for P. aeruginosa, single colonies were used to inoculate TSB broth cultures incubated overnight), single colonies were used to inoculate YPD broth cultures in Erlenmeyer flasks and incubated overnight at 37° C. with orbital shaking at 150 revolutions min⁻¹. Cultures were washed twice in RPMI 1640 and diluted to 125,000 cells ml⁻¹. Aliquots (100 ml) of the cell suspension were transferred to 96-well microtiter plates (Greiner Bio-One, Stonehouse, UK), either coated with the polymers of interest or containing coupons 3D-printed with polymer as described above and then incubated statically for 2 hours. Similarly, 100 ml of fungal spores (2.5×106 spores ml-1 in PDB) from 7-day-old PDA plates were transferred to coated 96-well plates for 6 hours at room temperature. In all cases, coupons were subsequently transferred to fresh 96-well plates. Non-adherent cells or spores were removed by three gentle washes with PBS; then, 100 ml of fresh medium was added to each well, and plates were incubated at 37° C. up to 24 hours after inoculation. Coupons were again transferred to fresh plates. The wells were washed three times with PBS, and the XTT reaction was initiated by adding XTT and menadione to RPMI (for C. glabrata and P. aeruginosa) to final concentrations of 210 mg ml-1 and 4.0 mM, respectively, or to PBS (for C. globosum and C. gloeosporioides) to final concentrations of 400 mg ml⁻¹ and 25 mM (final volume per well, 200 ml; PBS was used). After 2 and 6 hours, respectively, 100 ml of the reaction solutions was transferred to fresh 96-well plates, and the absorbance at 490 nm was measured using a BioTek EL800 microplate spectrophotometer. To assess the impact of the polymers on fungal growth, washing steps were omitted. The XTT reaction cannot be performed in PDB medium, and fungi are not able to grow in PBS. Therefore, C. globosum and C. gloeosporioides was cultivated for 15 days on the polymers in the presence of PDB, and growth effects were assessed visually.

The results of these assays showed that printed samples according to the invention were able to have a significant effect in terms of reduction of attachment for microbes. In particular, the PA-12 coated with p (IBMA-bornyl methacrylate) had a strong inhibitory effect against attachment for all four tested organisms.

### Examples 9-10: Conclusion

It has been shown that it is possible to obtain core-shell polymer particles in which anti-microbial functionality is part of the copolymeric outer shells, with each sample including anti-microbial moieties in the minor monomer.

These coatings could be made reliably and with different concentrations of the biologically active monomers.

Overall, the bioassays showed an inhibitory effect towards the growth of a diverse group of biological organisms.

The particles can be 3D printed using powder bed fusion (PBF) techniques, such as SLS.

1. A particulate material suitable for use in manufacturing a three-dimensional object, the material comprising a plurality of particles each of which has:
a thermoplastic polymeric core; and
a polymeric shell that coats the polymeric core;
wherein the polymeric core makes up 75 wt % or more of each particle,
wherein the polymeric shell is formed from a co-polymer of a major monomer and a minor monomer,
wherein the major monomer comprises a polymerisable group,
wherein the minor monomer comprises (i) a polymerisable group; and (ii) a functional component,
and wherein the co-polymer is formed by reaction of the polymerisable group on the major monomer with the polymerisable group on the minor monomer.

2. The particulate material of claim 1, wherein the minor monomer comprises a functional component which is a functional moiety providing one or more of the following properties: colour, anti-static, hydrogen bonding, electro-dispersive, amphiphilic, hydrophobic, hydrophilic, oleophobic, oleophilic, anti-microbial, flame-retardant, anti-viral, anti-reflective, super-reflective, infra-red absorptive, conductive, crosslinking, and strength.

3. The particulate material of claim 2, wherein the functional moiety provides one or more of the following properties: colour, hydrogen bonding, hydrophobic, hydrophilic, anti-microbial, flame-retardant, and conductive.

4. The particulate material of claim 3, wherein the functional moiety provides one or more of the following properties: colour, anti-microbial, flame-retardant, and conductive.

5. The particulate material of claim 4, wherein the minor monomer includes a functional moiety that is a dye, which optionally is an azo dye or an anthraquinone dye.

6. The particulate material of claim 1 or claim 2, wherein the functional component is a reactive double bond or other crosslinking functional moiety.

7. The particulate material of any one of the preceding claims, wherein the co-polymer comprises the minor monomer in an amount of:
a) from 0.5 to 30 wt %; or
b) from 0.5 to 25 wt %; or
c) from 1 to 20 wt %; or
d) from 2 to 15 wt %.

8. The particulate material of any one of the preceding claims, wherein the polymeric core is selected from:
polyamides,
polyetherketoneketone,
acrylonitrile butadiene styrene,
thermoplastic elastomers,
polypropylene,
thermoplastic polyurethane,
polyacrylamide,
poly methyl methacrylate,
polystyrene,
polycarbonates,
polylactic acid,
polyethylene or polyethylene chloride,
polyethylene oxide.

9. The particulate material of any one of the preceding claims, wherein the polymeric core makes up a proportion of the total weight of each particle that is:
a) from 75 to 99 wt %, or
b) from 80 to 95 wt %, or
c) from 85 to 90 wt %.

10. The particulate material of any one of the preceding claims, wherein the major monomer makes up a proportion of the total weight of the co-polymer shell that is:
a) from 75 to 99 wt %, or
b) from 80 to 98 wt %, or
c) from 85 to 97.5 wt %.

11. The particulate material of any one of the preceding claims, wherein the major monomer is a monomer that, when polymerised, has a T_{g} that differs from the Tm of the thermoplastic polymer that forms the polymer core by no more than 10° C.

12. The particulate material of any one of the preceding claims, wherein the major monomer comprises a polymerisable group selected from: acrylate, methacrylate, acrylamide, methacrylamide, epoxy, isocyanate, and vinyl.

13. The particulate material of any one of the preceding claims, wherein the minor monomer comprises a polymerisable group selected from: acrylate, methacrylate, acrylamide, methacrylamide, epoxy, isocyanate, and vinyl.

14. The particulate material of any one of the preceding claims, wherein the major monomer is isobornyl methacrylate or methyl methacrylate or alpha pinene methacrylate or ethyl methacrylate or 4-bromostyrene or 2,6-diphenylphenol or 4-chlorophenyl vinyl ketone.

15. The particulate material of any one of the preceding claims, wherein the polymeric core and the major monomer are selected from the following table:

| Polymeric core | Major monomer |
|---|---|
| PA-12 | isobornyl methacrylate |
| | or alpha pinene methacrylate |
| PA-11 | isobornyl methacrylate |
| | or alpha pinene methacrylate |
| poly(ethylene) | 4-bromostyrene |
| poly(ethylene oxide) | ethyl methacrylate |
| poly(6-aminocaproic acid) | 2,6-diphenylphenol |
| poly(ethylene chloride) | 4-chlorophenyl vinyl ketone |
| poly (methyl methacrylate) | methyl methacrylate |

16. The particulate material of any one of the preceding claims, wherein the major monomer is isobornyl methacrylate or methyl methacrylate or alpha pinene methacrylate or beta pinene methacrylate.

17. The particulate material of any one of the preceding claims, wherein the major monomer is isobornyl methacrylate and the polymeric core is PA-12.

18. A kit comprising two or more different particulate materials as defined in any one of the preceding claims, wherein the minor monomer includes a functional moiety that is a dye, and wherein each particulate material includes a dye that is a different colour.

19. The kit of claim 18, wherein the kit comprises three different particulate materials, one having a blue dye, one having a yellow dye and one having a red dye.

20. A kit comprising two or more different particulate materials as defined in any one of claims 1 to 17, wherein each minor monomer includes a functional moiety that imparts crosslinking, wherein there is a first particulate material whereby the minor monomer includes a crosslinking functional moiety, and wherein there is a second particulate material whereby the minor monomer includes a crosslinking functional moiety, where the first and second particulate materials are different and where the crosslinking functional moiety in the first particulate material is able to crosslink with the crosslinking functional moiety in the second particulate material.

21. The kit of claim 20, wherein the polymeric shell of the first particulate material is not the same as the polymeric shell of the second particulate material due to the major monomer being different and/or due to the minor monomer being different.

22. The kit of claim 21, wherein the crosslinking functional moiety in the first particulate material is different from the crosslinking functional moiety in the second particulate material.

23. The kit of claim 22, wherein there is a first particulate material whereby the minor monomer includes a functional moiety that is an alcohol, and wherein there is a second particulate material whereby the minor monomer includes a functional moiety that is an epoxide; or wherein there is a first particulate material whereby the minor monomer includes a functional moiety that is an alcohol, and wherein there is a second particulate material whereby the minor monomer includes a functional moiety that is an acid.

24. A method of manufacturing particulate material according to any one of claims 1 to 17, wherein the method comprises:
i) providing a thermoplastic polymer in particulate form;
ii) providing a major monomer and a minor monomer, as defined in any one of claims 1 to 17;
and then
iii) carrying out polymerisation of the major monomer and the minor monomer, so as to form a polymeric shell that coats the particulate thermoplastic polymer.

25. The method of claim 24, wherein the polymerisation is carried out in supercritical CO₂.

26. The method of claim 24 or claim 25, wherein a RAFT agent is used in the polymerisation.

27. A method of manufacturing a three-dimensional object, where the method comprises:
a) providing particulate material as defined in any one of claims 1 to 17;
b) depositing the particulate material; and
c) selectively fusing the deposited particulate material;
so as to obtain a three-dimensional object.

28. The method of claim 27, wherein the method is a powder bed fusion (PBF) 3D printing technique.

29. The method of claim 28, wherein the method is Multi Jet Fusion (MJF) or Selective Laser Sintering (SLS).

30. The method of any one of claims 27 to 29, wherein in step a) two or more different particulate materials as defined in any one of claims 1 to 17 are provided, wherein the functional molecule is a dye, and wherein each particulate material includes a dye that is a different colour, and these materials are mixed together before being deposited in step b).

31. The method of any one of claims 27 to 29, wherein in step a) two or more different particulate materials as defined in any one of claims 1 to 17 are provided, wherein each minor monomer includes a functional moiety that imparts crosslinking, wherein there is a first particulate material whereby the minor monomer includes a crosslinking functional moiety, and wherein there is a second particulate material whereby the minor monomer includes a crosslinking functional moiety, where the first and second particulate materials are different and where the crosslinking functional moiety in the first particulate material is able to crosslink with the crosslinking functional moiety in the second particulate material, and wherein these materials are mixed together before being deposited in step b).

32. The use of particulate material as defined in any one of claims 1 to 17 to impart one or more of the following properties to a three-dimensional product: colour, anti-static, hydrogen bonding, electro-dispersive, amphiphilic, hydrophobic, hydrophilic, oleophobic, oleophilic, anti-microbial, flame-retardant, anti-viral, anti-reflective, super-reflective, infra-red absorptive, conductive, and mechanical and physical properties such as strength.

33. The use according to claim 32, wherein the particulate material is used to form the three-dimensional product by a powder bed fusion (PBF) 3D printing technique, such as Multi Jet Fusion (MJF) or Selective Laser Sintering (SLS).
